(19) United States
(12) Patent Application Publication
(10) Pub. No.: US 2026/0036715 A1
(43) Pub. Date: Feb. 5, 2026

(54) Wind Predictions Using Artificial Intelligence

(71) Applicant: Zesty.ai, Inc., Oakland, CA (US)

(72) Inventors: Frederick Dube Fortier, Oakland, CA (US); Ezhilmalar Jayabalan, Toronto (CA); Harsimrenjit Singh, Ottawa (CA); Megil Gallant, Saint John (CA); Alexander Kallos, Toronto (CA); Charles Lau, Toronto (CA)

(21) Appl. No.: 18/789,427

(22) Filed: Jul. 30, 2024

(51) Int. Cl. G01W 1/10; G01P 5/00; G06Q 40/08

(52) U.S. Cl. CPC G01W 1/10; G01P 5/00; G06Q 40/08

(57) ABSTRACT

The disclosure includes systems and methods for receiving, using one or more processors, a location, determining a wind speed associated with the location using a first wind speed machine learning model, determining a wind report frequency associated with the location using a first wind report frequency machine learning model, obtaining first feature data associated with the location including the wind speed associated with the location, the wind report frequency associated with the location, and data describing a first set of features at the location, determining a damage frequency metric associated with the location by applying a first damage frequency machine learning model to the first feature data, obtaining second feature data associated with the location including data describing a second set of features at the location, and determining a damage severity metric associated with the location by applying a first damage severity machine learning model to the second feature data.

### BACKGROUND

The present disclosure generally relates to systems and methods for determining predictions associated with wind using artificial intelligence. In particular, the present disclosure relates to systems and methods for determining the likelihood and/or extent of property damage from wind.

Climate events, such as storms, cause damage, including wind damage. However, there are no existing ways of accurately predicting the likelihood and scope of damage posed by a climate event to a property, much less ways to accurately predict the likelihood and scope of damage posed by a climate event to a property that accounts for the property-specific attributes of that property.

### SUMMARY

This specification relates to methods and systems for making predictions associated with wind. In general, an innovative aspect of the subject matter described in this disclosure may be implemented in methods that include receiving, using one or more processors, a location, determining, using the one or more processors, a wind speed associated with the location using a first wind speed machine learning model, determining, using the one or more processors, a wind report frequency associated with the location using a first wind report frequency machine learning model, obtaining, using the one or more processors, first feature data associated with the location, the first feature data including the wind speed associated with the location, the wind report frequency associated with the location, and data describing a first set of features at the location, determining, using the one or more processors, a damage frequency metric associated with the location by applying a first damage frequency machine learning model to the first feature data, obtaining, using the one or more processors, second feature data associated with the location, the second feature data including data describing a second set of features at the location, and determining, using the one or more processors, a damage severity metric associated with the location by applying a first damage severity machine learning model to the second feature data.

Other implementations of one or more of these aspects include corresponding systems, apparatus, and computer programs, configured to perform the actions of the methods encoded on computer storage devices.

These and other implementations may each optionally include one or more of the following features. The location may be represented by a latitude and longitude. The wind speed may be represented as an average wind speed associated with the location. The wind report frequency represents one or more of a frequency of a wind report and a frequency of a wind report having an average wind speed that exceeds a threshold. One or more of the first set of features includes one or more of: a vegetation density, a roof resilience score, a number of roof penetrations, a roof quality, one or more reasons generated by a roof quality reasoning model, a land cover code, a temperature, and a precipitation metric. The one or more features at the location include a first feature obtained by applying a feature model to an aerial image of the location. The feature model may be a convolutional neural network. The method(s) may also include determining, based on one or more of the damage frequency metric and the damage severity metric, one or more of: a remedial action to reduce a wind damage metric; a determination of the wind damage metric; a warning to one or more of a property owner, a resident, and an entity associated with the location, the warning comprising the wind damage metric. The first set of features at the location and the second set of features at the location may not be mutually exclusive. The second set of features includes one or more of a building area, a vegetation density, a roof material, a roof quality, a roof pitch, a roof height, a roof shape, a temperature, a temperature variation, and a precipitation metric.

### BRIEF DESCRIPTION OF THE DRAWINGS

The disclosure is illustrated by way of example, and not by way of limitation in the figures of the accompanying drawings in which like reference numerals are used to refer to similar elements.

FIG. 1 is a block diagram of one example system for wind prediction in accordance with some implementations.

FIG. 2 is a block diagram of an example server in accordance with some implementations.

FIG. 3 is a block diagram of an example wind predictor in accordance with some implementations.

FIG. 4 is a block diagram of an example climatology modeler in accordance with some implementations.

FIG. 5 is a block diagram of an example damage frequency modeler in accordance with some implementations.

FIG. 6 is a block diagram of an example damage frequency model feature determiner in accordance with some implementations.

FIG. 7 is a block diagram of a damage severity modeler in accordance with some implementations.

FIG. 8 is a flowchart of an example method for making one or more wind predictions in accordance with some implementations.

FIG. 9 is a flowchart of an example method for training frequency of damage model(s) in accordance with some implementations.

FIG. 10 is a flowchart of an example method for training a damage severity model in accordance with some implementations.

FIG. 11 illustrates example diagrams based on the wind data set(s) associated with the continental United States in accordance with some implementations.

FIG. 12 illustrates an example diagram of a wind model in accordance with some implementations.

FIG. 13 is a block diagram of an example damage severity model feature determiner in accordance with some implementations.

FIG. 14 illustrates an example variogram in accordance with some implementations.

### DETAILED DESCRIPTION

Wind events may include many types of wind, including straight-line wind that defines any thunderstorm wind that is not associated with rotation and is mainly used to differentiate from tornadic winds; frontal and coastal winds, where frontal winds arise from anywhere in the United States and where coastal winds stem from large storm systems moving onshore; damaging winds that are synonymous with straight-line winds exceeding 50-60 mph; windstorm that includes a wind strong enough to cause light damage to trees and buildings and may or may not be accompanied by precipitation, where wind speeds during a windstorm typically exceed 34 miles per hour (tornadoes and tropical cyclones are usually classified separately); tornado that is defined as a narrow, violently rotating column of air that extends from a thunderstorm to the ground, where strength is measured from 0-5 by the Enhanced-Fujita scale; hurricane (or tropical cyclone) that is defined as a swirling low-pressure system that develops over the Atlantic basin (Atlantic Ocean, Caribbean Sea, and Gulf of Mexico, the eastern North Pacific Ocean, and less frequently, the central North Pacific Ocean) with sustained winds that have reached at least 74 miles per hour, where strength is measured from category 1-5 with the Saffir-Simpson scale; derecho defined as a widespread, long-lived, straight-line wind storm that is associated with a fast-moving group of severe thunderstorms; tropical storms, including a tropical depression defined as a tropical cyclone with maximum sustained winds of less than or equal to 38 mph, a tropical storm defined as a tropical cyclone with maximum sustained winds of 39 to 73 mph, hurricane defined as a tropical cyclone with maximum sustained winds of 74 mph or higher (also known as typhoons in the western North Pacific; similar storms in the Indian Ocean and South Pacific Ocean are called cyclones), and major hurricane defined as a tropical cyclone with maximum sustained winds of 111 mph or higher, corresponding to a category 3, 4, or 5 on the Saffir-Simpson Hurricane Wind Scale; named storm defined as any storm declared by the US National Hurricane Center, US Central Pacific Hurricane Center, US Weather Prediction Center, or their successor organizations to be a tropical storm or hurricane (does not include tornadoes or severe thunderstorms); and thunderstorm defined as a rain shower during which thunder is heard and always accompanied by lightning, where a severe thunderstorm has any of the following: hail one inch or greater, winds gusting in excess of 57.5 mph, or a tornado.

Wind events may generate wind data sets that are gathered and/or modeled for the contiguous United States using the techniques described herein. Though the wind datasets described here cover the United States, the methods and techniques could be used for wind events in other regions that generate wind data. A separate assertion frequency binary model predicts whether a wind-related roof reimbursement request will happen in a given year, in an implementation. The model uses at least eleven (11) features, including 6 that are property features generated from models based on aerial imagery, 3 that are GIS features, 1 that is wind-related feature produced from the National Oceanic and Atmospheric Administration (NOAA)'s Storm Prediction Center (SPC) wind report dataset, and a derived feature, which further needs 2 property features for its calculation. In other implementations, the model may be converted to produce predictions in the range of 1-10, with each prediction score from 1 to 10 indicating a likelihood of the damage assertion occurring, with a higher score indicating a higher likelihood of damage.

The techniques introduced herein overcome the deficiencies and limitations of the prior art, at least in part, by providing systems and methods for determining wind damage risk using artificial intelligence. In some implementations, the systems and methods of the present disclosure create and use one or more wind models to determine the frequency at which a location/property will be affected by a wind event and make predictions about those wind events. In some implementations, the present disclosure also describes creating and using the models to determine a likelihood of damage (or a reimbursement request for damage) and the severity of the damage (or of the reimbursement request for damage) from the wind event.

While the present disclosure is described below primarily in the context of wind, the models, systems, and methods of the present disclosure may be adapted to other climate events. For example, in other implementations, the models, systems, and methods of the present disclosure may be used in a similar way to determine the probability of damage and the extent of damage from tornadoes, hurricanes or cyclones, dust storms, and other wind-related events, even though the present disclosure is described primarily in the context of wind. It should be understood that the models, systems, and methods may be modifiable, or adjustable, and applicable to other climate events, and remain within the scope of the present disclosure.

One particular advantage of the systems and methods of the present disclosure is the use of artificial intelligence or machine learning. While the systems and methods of the present disclosure are described below in the context of some implementations using particular algorithms and/or types (e.g., supervised) of machine learning, it should be understood that the systems and methods of the present disclosure may be implemented using other machine learning approaches such as, but not limited to semi-supervised learning, unsupervised learning, reinforcement learning, topic modeling, dimensionality reduction, meta-learning, and deep learning.

The systems and methods of the present disclosure have a number of advantages over prior art systems and methods. The systems and methods of the present disclosure advantageously leverage property-specific information such as vegetation, buildings materials, etc., to predict a likelihood (e.g., frequency) of damage from a climate event (e.g., wind) and an extent (or severity of damage) when the property is involved in a climate event (e.g., wind). Additionally, some implementations leverage machine learning to derive such property-specific information (occasionally referred to herein as feature data) efficiently and accurately from readily available data sources (e.g., aerial imagery) which may eliminate the need for human onsite inspection. All of these above advantages are achieved by the systems and methods of the present disclosure, which include:

Methods for generating climatological models (e.g., describing expected average wind speed, maximum wind speed and/or wind frequency at a location) using statistical methods (e.g., AI/ML).

Methods for generating a damage frequency model (e.g., to predict a damage frequency metric or expected likelihood of a wind reimbursement request) using statistical methods (e.g., AI/ML).

Methods for generating a damage severity model (e.g., describing an extent of the damage expected or reimbursement requested) using statistical methods (e.g., AI/ML).

### Example System

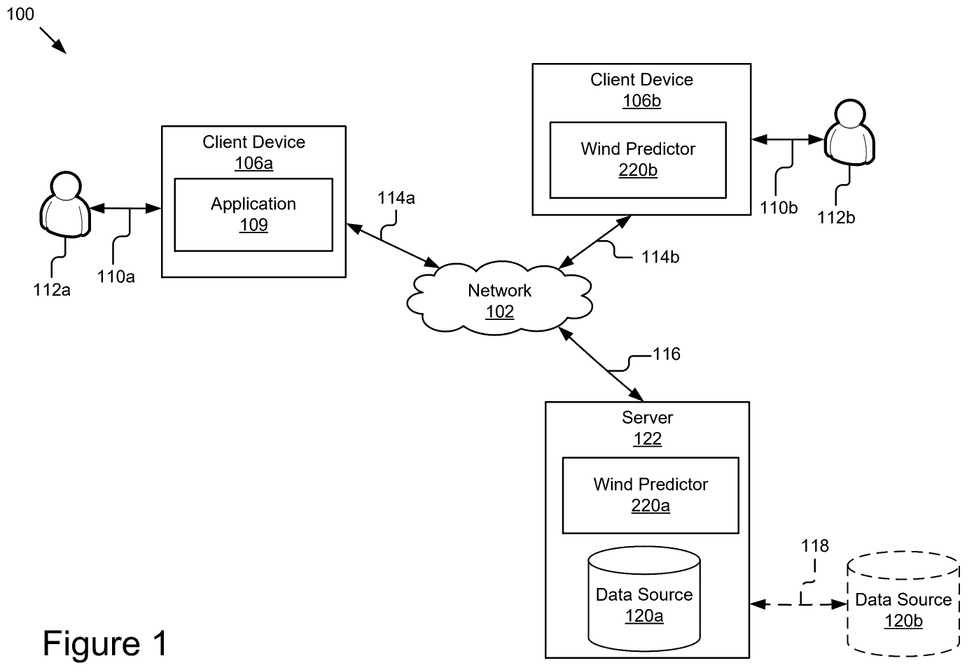

FIG. 1 is a block diagram of one example system for making predictions associated with wind using artificial intelligence in accordance with some implementations. As depicted, system 100 includes server 122 and client devices 106a and 106b coupled for electronic communication via network 102. The client devices 106a or 106b may occasionally be referred to herein individually as client device 106 or collectively as client devices 106. Although two client devices 106a and 106b are shown in FIG. 1, it should be understood that there may be any number of client devices 106.

A client device 106 is a computing device that includes a processor, memory, and network communication capabilities (e.g., a communication unit). The client device 106 is coupled for electronic communication to network 102 as illustrated by signal line 114. In some implementations, the client device 106 may send and receive data to and from other entities of the system 100 (e.g., a server 122). Examples of client devices 106 may include, but are not limited to, mobile phones (e.g., feature phones, smartphones, etc.), tablets, laptops, desktops, netbooks, portable media players, personal digital assistants, etc.

It should be understood that system 100, depicted in FIG. 1, is provided by way of example, and system 100 and/or further systems contemplated by this present disclosure may include additional and/or fewer components, may combine components and/or divide one or more of the components into additional components, etc. For example, system 100 may include any number of client devices 106, networks 102, or servers 122.

In some implementations, the client device 106 includes an application 109. Depending on the implementation, the application may include a dedicated application or a browser (e.g., a web browser such as Chrome, Firefox, Edge, Explorer, Safari, or Opera). In some implementations, a user 112 accesses the features and functionalities of the wind predictor 220a/b via the application 109.

The network 102 may be a conventional type, wired and/or wireless, and may have numerous different configurations, including a star configuration, token ring configuration, or other configurations. For example, network 102 may include one or more local area networks (LAN), wide area networks (WAN) (e.g., the Internet), personal area networks (PAN), public networks, private networks, virtual networks, virtual private networks, peer-to-peer networks, near field networks (e.g., Bluetooth®, NFC, etc.), cellular (e.g., 4G or 5G), and/or other interconnected data paths across which multiple devices may communicate.

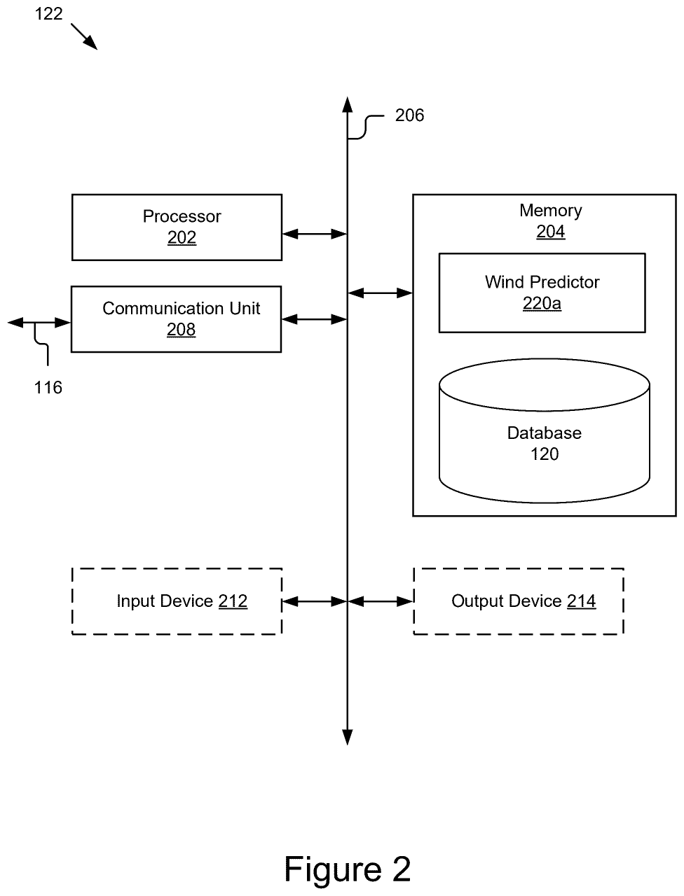

Server 122 is a computing device that includes a hardware and/or virtual server that includes a processor, memory, and network communication capabilities (e.g., a communication unit). Server 122 may be communicatively coupled to network 102, as indicated by signal line 116. In some implementations, server 122 may send and receive data to and from other entities of the system 100 (e.g., one or more client devices 106). Some implementations for server 122 are described in more detail below with reference to FIG. 2.

Data source 120a is a non-transitory memory that stores data for providing the functionality described herein. The data source 120a/b may include one or more non-transitory computer-readable mediums for storing the data. In some implementations, the data source 120a may be incorporated with the memory of server 122, or the data source 120b may be distinct from server 122 and coupled thereto. In some implementations, the data source 120 may be remote from server 122, as illustrated by instance 120b. For example, in some implementations (not shown), the data source 120b may include network-accessible storage and/or one or more third-party data sources that store and maintain data used to provide the functionality described herein.

The data source 120 may be a dynamic random-access memory (DRAM) device, a static random-access memory (SRAM) device, a flash memory, or some other memory device. In some implementations, the data source 120 may include a database management system (DBMS) operable on server 122. For example, the DBMS could include a structured query language (SQL) DBMS, a NoSQL DMBS, various combinations thereof, etc. In some instances, the DBMS may store data in multi-dimensional tables comprised of rows and columns and manipulate, e.g., insert, query, update and/or delete, rows of data using programmatic operations. In other implementations, the data source 120a/b also may include a non-volatile memory or similar permanent storage device and media, including a hard disk drive, a CD-ROM device, a DVD-ROM device, a DVD-RAM device, a DVD-RW device, a flash memory device, or some other mass storage device for storing information on a more permanent basis.

The data source 120 stores data for providing the functionality described herein. The data may vary based on the implementation and climate event(s) being assessed. Examples of data that data source 120 may store include, but are not limited to, one or more image data (e.g., aerial images, satellite images, etc.), damage or loss data, insurance data, historic climate event data, weather data (e.g., average temperature, average wind speeds annually, maximum wind speeds, etc.), boundary definitions (e.g., flood zones), emergency service locations (e.g., fire department locations), and topographical or other maps.

Other variations and/or combinations are also possible and contemplated. It should be understood that system 100 illustrated in FIG. 1 is representative of an example system and that a variety of different system environments and configurations are contemplated and are within the scope of the present disclosure. For example, various acts and/or functionality may be moved from a server to a client, or vice versa, data may be consolidated into a single data store or further segmented into additional data stores, and some implementations may include additional or fewer computing devices, services, and/or networks, and may implement various functionality client or server-side. Furthermore, various entities of the system may be integrated into a single computing device or system or divided into additional computing devices or systems, etc.

For example, depending on the implementation, the wind predictor 220 may be entirely server-side, i.e., at wind predictor 220a, entirely client-side, i.e., at wind predictor 220b, or distributed to between the client-side and server-side, i.e., at wind predictor 220a and wind predictor 220b.

As another example, while only a single server 122 is illustrated, server 122 may represent a plurality of servers (e.g., a server farm or distributed cloud environment), and server 122, in some implementations, may, therefore, include multiple instances (e.g., in different hardware servers, virtual machines, or containers) of the wind predictor 220a.

FIG. 2 is a block diagram of an example server 122, including an instance of the wind predictor 220a. In the illustrated example, server 122 includes a processor 202, a memory 204, a communication unit 208, and, optionally, an input device 212 and an output device 214.

The processor 202 may execute software instructions by performing various input/output, logical, and/or mathematical operations. The processor 202 may have various computing architectures to process data signals, such as a complex instruction set computer (CISC) architecture, a reduced instruction set computer (RISC) architecture, and/or an architecture implementing a combination of instruction sets. The processor 202 may be physical and/or virtual. Processor 202 may include a single processing unit or a plurality of processing units and/or cores. In some implementations, the processor 202 may be capable of generating and providing electronic display signals to a display device, supporting the display of images, capturing and transmitting images, and performing complex tasks and determinations. In some implementations, the processor 202 may be coupled to the memory 204 via the bus 206 to access data and instructions therefrom and store data therein. Bus 206 may couple the processor 202 to the other components of the server 122 including, for example, the memory 204, and the communication unit 208.

Memory 204 may store and provide access to data for the other components of server 122. Memory 204 may be included in a single computing device or distributed among a plurality of computing devices. In some implementations, memory 204 may store instructions and/or data that may be executed by processor 202. The instructions and/or data may include code for performing the techniques described herein. For example, in some implementations, memory 204 may store an instance of the wind predictor 220a. Memory 204 is also capable of storing other instructions and data, including, for example, an operating system, hardware drivers, other software applications, databases (e.g., data source 120), etc. The memory 204 may be coupled to bus 206 for communication with processor 202 and the other components of server 122.

Memory 204 may include one or more non-transitory computer-usable (e.g., readable, writeable) devices, a static random access memory (SRAM) device, a dynamic random access memory (DRAM) device, an embedded memory device, a discrete memory device (e.g., a PROM, FPROM, ROM), a hard disk drive, an optical disk drive (CD, DVD, Blu-Ray™, etc.) mediums, which can be any tangible apparatus or device that can contain, store, communicate, or transport instructions, data, computer programs, software, code, routines, etc., for processing by or in connection with the processor 202. In some implementations, memory 204 may include one or more volatile memory and non-volatile memory. It should be understood that memory 204 may be a single device or may include multiple types of devices and configurations.

The communication unit 208 is hardware for receiving and transmitting data by linking processor 202 to network 102 and other processing systems. Communication unit 208 receives data and transmits the data via network 102. The communication unit 208 is coupled to bus 206. In some implementations, the communication unit 208 may include a port for direct physical connection to network 102 or to another communication channel. For example, communication unit 208 may include an RJ45 port or similar port for wired communication with the network 102. In another implementation, the communication unit 208 may include a wireless transceiver (not shown) for exchanging data with the network 102 or any other communication channel using one or more wireless communication methods, such as IEEE 802.11, IEEE 802.16, Bluetooth® or another suitable wireless communication method.

In yet another implementation, the communication unit 208 may include a cellular communications transceiver for sending and receiving data over a cellular communications network, such as via short messaging service (SMS), multimedia messaging service (MMS), hypertext transfer protocol (HTTP), direct data connection, WAP, e-mail or another suitable type of electronic communication. In still another implementation, the communication unit 208 may include a wired port and a wireless transceiver. The communication unit 208 also provides other connections to network 102 for the distribution of files and/or media objects using standard network protocols such as TCP/IP, HTTP, HTTPS, and SMTP as will be understood to those skilled in the art.

The input device 212 may include any device for inputting information into server 122. In some implementations, the input device 212 may include one or more peripheral devices. For example, the input device 212 may include a keyboard, a pointing device, a microphone, an image/video capture device (e.g., a camera), a touch-screen display integrated with the output device 214, etc.

The output device 214 may be any device capable of outputting information from server 122. The output device 214 may include one or more of a display (LCD, OLED, etc.), a printer, a 3D printer, a haptic device, an audio reproduction device, a touch-screen display, a remote computing device, etc. In some implementations, the output device 214 is a display that may display electronic images and data output by a processor for presentation to a user.

It should be apparent to one skilled in the art that other processors, operating systems, inputs (e.g., keyboard, mouse, one or more sensors, microphone, etc.), outputs (e.g., a speaker, display, haptic motor, etc.), and physical configurations are possible and within the scope of the disclosure.

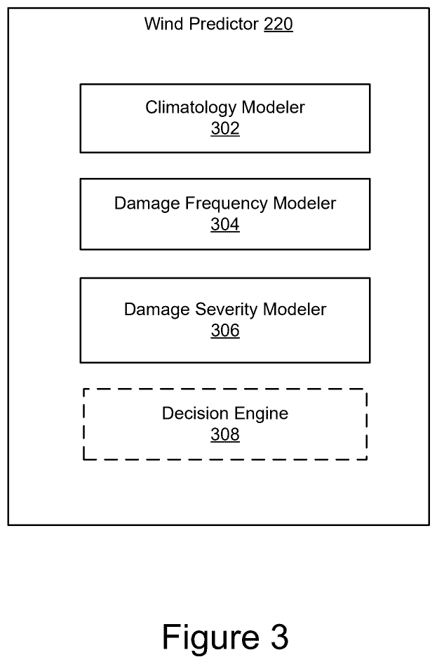

Referring now to FIG. 3, a block diagram of an example instance of the wind predictor 220 is illustrated in accordance with some implementations. In the illustrated implementation, the wind predictor 220 includes a climatology modeler 302, a damage frequency modeler 304, a damage severity modeler 306, and a decision engine 308. In some implementations, the decision engine 308 is optional and may be omitted. In some implementations, the components 302, 304, 306, and 308 of the wind predictor 220 are communicatively coupled with one another and/or other components of the system 100 or server 122, such as a data source 120.

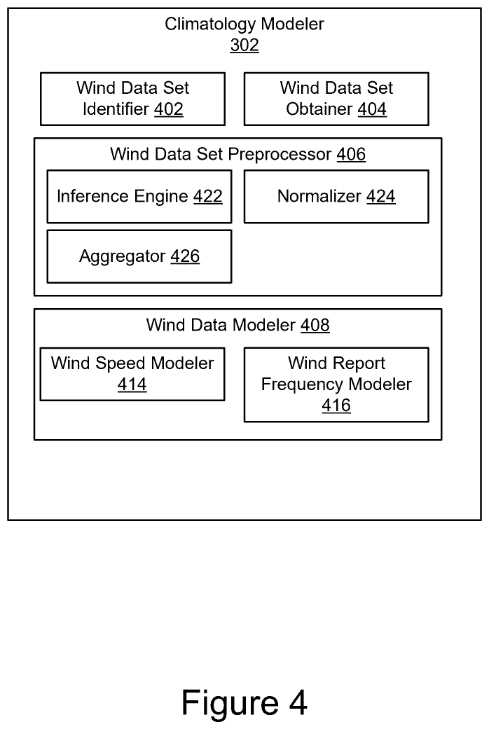

In some implementations, the climatology modeler 302 trains, validates and applies one or more climatology models to predict one or more of at least one characteristic of a wind event at the requested location and a frequency of a wind event having a specific characteristic. Depending on the implementation, a characteristic of the wind event may vary and include, by way of example and not limitation, one or more of an average reported wind speed (e.g., annually or seasonally), an average maximum reported wind speed (e.g., annually or seasonally), an average wind report frequency (e.g., annually or seasonally), etc. Depending on the implementation, the frequency of a wind event having a specific characteristic may vary and include, by way of example and not limitation, one or more of a frequency of wind event occurring that has the potential to cause damage (e.g., above a threshold wind speed or a combination of factors), a frequency of a wind warning, etc. The climatology modeler 302 is described further below with reference to FIG. 4 in accordance with some implementations.

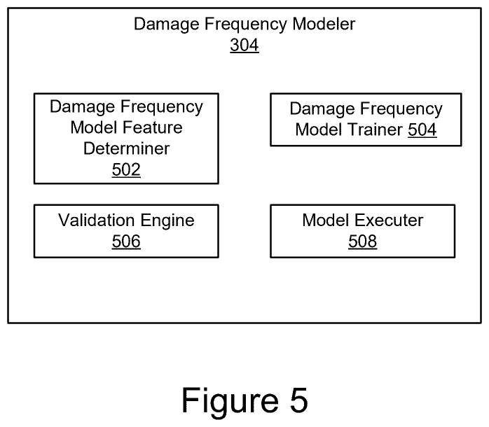

In some implementations, the damage frequency modeler 304 trains, validates, and applies one or more models to determine the probability of wind damage occurring. In an implementation, the raw datasets include property addresses that have had roof-related reimbursement requests for various perils and an amount of properties that have not had any reimbursement requests. These datasets are combined and filtered to include all or a subset of only wind, tornado, hurricane, and no-reimbursement request data. For example, assume the class distribution of data includes 20,721 properties that had wind reimbursement requests, 694 properties that had tornado reimbursement requests, 2,005 properties that had hurricane reimbursement requests, and 37,762 properties that had no reimbursement requests. In an implementation, this dataset may be split into three buckets: training (46,775), validation (5,851), and testing (5,857). In some implementations, the damage frequency modeler 304 determines a probability of a reimbursement request for the damage being made. In some implementations, the damage frequency modeler 304 uses features of one or more of the locations, the structures, and the surroundings to beneficially increase the accuracy of the predictions associated with wind damage made by the damage frequency modeler 304. In some implementations, the features may include, but are not limited to, one or more of: roof quality and the reasons for the roof quality designation (such as missing shingles, patched shingles, tarps, discoloration, wear, etc.), temperature, roof resilience score, vegetation density, precipitation, landcover, wind frequency, and roof penetrations. In an implementation, the reasons for the roof quality designation may be generated by a roof quality reasoning model and the reasons may be encoded. In some implementations, one or more of the roof quality and its associated reasons (e.g., the reasons for the roof quality designation (such as missing shingles, patched shingles, tarps, wear, etc.), roof material, vegetation density, and roof penetrations may be derived by the damage frequency modeler 304 from high-definition aerial imagery, e.g., one or more of vertical, oblique, panoramic, or other aerial imagery such as that provided by Nearmap, Vexcel, Eagle View or similar providers. In some implementations, one or more of the temperature, precipitation, and landcover, may be determined by the damage frequency modeler 304 using a Geographic Information System (e.g., Google Maps, ArcGIS, Carto, etc.) to map those features. In some implementations, one or more of the wind-related features, such as wind frequency, may be derived from SPC Severe Weather Reports, modeled using the techniques described herein, or a combination thereof. The damage frequency modeler 304 is described further below with reference to FIG. 5 in accordance with some implementations.

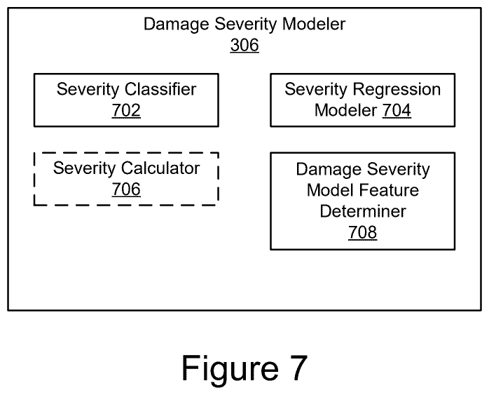

In some implementations, the damage severity modeler 306 trains, validates, and applies one or more models to predict the severity of wind damage. Depending on the implementation, the damage severity modeler 306 may determine the severity using one or more measures including, but not limited to; a roof area damaged, a roof area to be replaced, a replacement cost, insurance claims dollars paid as a proportion of property value covered, etc. The damage severity modeler 306 may calculate a severity metric based on these measures, in an implementation. In some implementations, the damage severity modeler 306 uses features of one or more of the locations, the structures, and the surroundings to beneficially increase the accuracy of the predictions associated with the wind damage made by the damage severity modeler 306. The damage severity modeler 306 is described further below with reference to FIG. 7 in accordance with some implementations.

In some implementations, the wind predictor 220 includes an optional decision engine 308. In some implementations, the decision engine 308 may be omitted or present in a separate component or system, e.g., in a third-party system, such as a server, or other computing devices, associated with an insurer (not shown).

The decision engine 308 obtains information generated by one or more of the climatology modeler 302, the damage frequency modeler 304, and the damage severity modeler 306 and makes one or more decisions based thereon. In some implementations, a decision is to initiate or take action. Examples of actions may include, but are not limited to, determining a remedial action to reduce risk, suggesting a remedial action, approving insurance coverage associated with the wind related risks and expected costs, denying insurance coverage associated with wind, identifying existing wind damage not covered by a future reimbursement request, approving or denying an insurance reimbursement request based on the absence or presence of prior (uncovered) wind damage, adjusting an insurance premium associated with wind, and sending a warning of the wind risk (e.g. via phone, e-mail, SMS/MMS text, mail, etc.) to the property or an owner, resident, financer, or insurer of the property.

In FIG. 4, a block diagram of an example climatology modeler 302 is illustrated in accordance with some implementations. In the illustrated implementation of FIG. 4, the climatology modeler 302 includes a wind data set selector 402, a wind data obtainer 404, a wind data set preprocessor 406, a wind data modeler 408, a wind speed modeler 414, and a wind report frequency modeler 416.

The wind data set identifier 402 identifies one or more wind data sets, i.e., one or more data sets associated with wind. In some implementations, the one or more data sets associated with wind describe one or more of (1) observed wind characteristic(s), e.g., wind speed or average wind speed, (2) a location of the observation, e.g., a latitude and longitude, (3) a time associated with the observation of the wind characteristic, e.g., time, date or year, and/or (4) modeled wind characteristic(s) based on observations of wind characteristics.

The one or more wind data sets identified by the wind set identifier 402, or available for identification thereby, may vary depending on the implementation and use case. In some implementations, the one or more wind data sets may be obtained from a trusted third party source. Examples of wind data sets may include, but are not limited to, one or more of National Renewables and Energy Laboratory's (NREL) Weather Research and Forecasting (WRF) data set, the National Oceanic and Atmospheric Administration (NOAA) Storm Prediction Center (SPC) data set, and the Federal Emergency Management Agency (FEMA) dataset. It should be recognized that the foregoing are data sets generated by United States Government agencies. However, data sets may be obtained for different geographic area(s) and from public or private sources without departing from the disclosure herein.

In some implementations, the wind data set identifier 402 identifies the one or more wind data sets based on user input. For example, the wind data set identifier 402 receives input from a user identifying the one or more wind data sets (e.g., a website, API, storage location, file, etc.), and the wind data set identifier 402 identifies the one or more wind data sets based on that identification.

In some implementations, the wind data set identifier 402 identifies one or more wind data sets from a set of candidate wind data sets. For example, assume that data sets from the National Renewables and Energy Laboratory's (NREL) Weather Research and Forecasting (WRF) data set, the SPC data set, and a Federal Emergency Management Agency (FEMA) data set are available as candidate wind data sets, as those data sets include data describing past wind observations. In some implementations, the wind data obtainer 404, the wind data set preprocessor 406, the model trainer 408, and the wind model validator 410, which are described below, may be executed using different permutations or combinations of wind data sets and the wind data set identifier 402 may obtain one or more results of those validations. For example, the wind data set identifier 402 obtains a performance metric (e.g., describing the accuracy of the wind model(s)) obtained using various permutations or combinations of different wind data sets. In some implementations, the wind data set identifier 402 evaluates the received performance metrics to determine which wind data set(s) are to be used to train the wind model(s). For example, assume that there was no improvement over a wind model trained using only a first wind data set (e.g., from the SPC), when using a model trained using the first data set and one or more other wind data sets (e.g., the FEMA and/or NREL data sets); in some implementations, the wind data set identifier 402 identifies the first wind data set. In some implementations, that identification of the first wind data set may be used for subsequent trainings or retrainings. For example, when retraining is due, the retraining may be based on only the first wind data set (i.e., the SPC wind data set in the previous example). Such identification may not only result in the most accurate model(s), but may streamline obtainment and preprocessing of the wind data set(s) by reducing the number of different data sets, the amount of data to be obtained, normalized/standardized, preprocessed, used to train, etc. This beneficially results in an improvement to the data model as well as increases efficiency and allotment of resources.

In some implementations, a wind data set may be identified by obtaining the results of modeled SPC wind data. For example, assume that SPC wind data includes severe wind report data from 2002-2022 grouped into 16 kilometer grids and averaged over the time span.

The wind data set obtainer 404 is communicatively coupled to obtain the identification of one or more wind data sets. For example, the wind data set identifier 402 may send the identification of the one or more wind data sets to the wind data set obtainer 404, or the wind data set identifier 402 may store (e.g., in data source 120 or memory 204) the identification of the one or more wind data sets for retrieval by the wind data set obtainer 404.

The wind data set obtainer 404 obtains one or more identified wind data sets from their associated source(s). For example, the wind data set obtainer 404 may query and receive a wind data set from a data source 120, request and receive the wind data set via an API, etc. In some implementations, the wind data set obtainer 404 may obtain only a portion of the one or more identified data sets. The portion obtained may vary based on the implementation, use case, and wind data set. In some implementations, the portion obtained may be based on a threshold. For example, in some implementations, the threshold may be based on time so that old wind data is excluded and more recent wind data is used to generate the model, e.g., a threshold for wind data generated in/describing wind in the last 5, 10, or 20 years. In some implementations, the portion obtained may be based on what feature(s) data in that portion describes. For example, assume that (e.g., by a process of feature reduction) temperature and/or humidity is not a feature used in the one or more wind models subsequently trained by the wind model trainer 408 but is present in the wind data set; in some implementations, the wind data set obtainer 404 may not obtain that portion of the wind data set. In some implementations, the portion(s) obtained may vary. For example, different portions may be selected for training, validation, production, and retraining of the various models described herein.

The wind data set preprocessor 406 is communicatively coupled to obtain the one or more wind data sets or portion(s) thereof. For example, the wind data set obtainer 404 may send the one or more wind data sets or portion(s) thereof to the wind data set preprocessor 406, or the wind data set obtainer 404 may store (e.g., in data source 120 or memory 204) the one or more wind data sets or portion(s) thereof for retrieval by the wind data set preprocessor 406.

The wind data set preprocessor 406 may include software and/or logic to provide the functionality for preprocessing wind data set(s) before using the wind data for training the one or more wind models. For example, the wind data set preprocessor 406, as illustrated in FIG. 4, may include an inference engine 422, a normalizer 424, and an aggregator 426.

It should be recognized that the climatology modeler 302 and the components thereof at least partially address one or more technical challenges associated with machine learning and data science generally and with characteristics of reported wind data set(s). For example, reported wind data set(s) present a number of technical challenges including but not limited to inconsistent data, missing data, imbalanced data, data integration, etc. For example, regional differences in reporting or changes in reporting over time may result in inconsistent data (e.g., mph vs kph for wind speed), data integration issues (e.g., inconsistent fields or schemas between data sets for different time periods or regions), etc. As another example, increased reporting from observers (storm chasers, researchers, citizen scientists, social media reports, use of Doppler radar imagery) clustered in higher population areas produces a reported wind data set that is imbalanced (e.g., has an urban bias) and may have missing data (e.g., for less populated and/or unmonitored portions of the country).

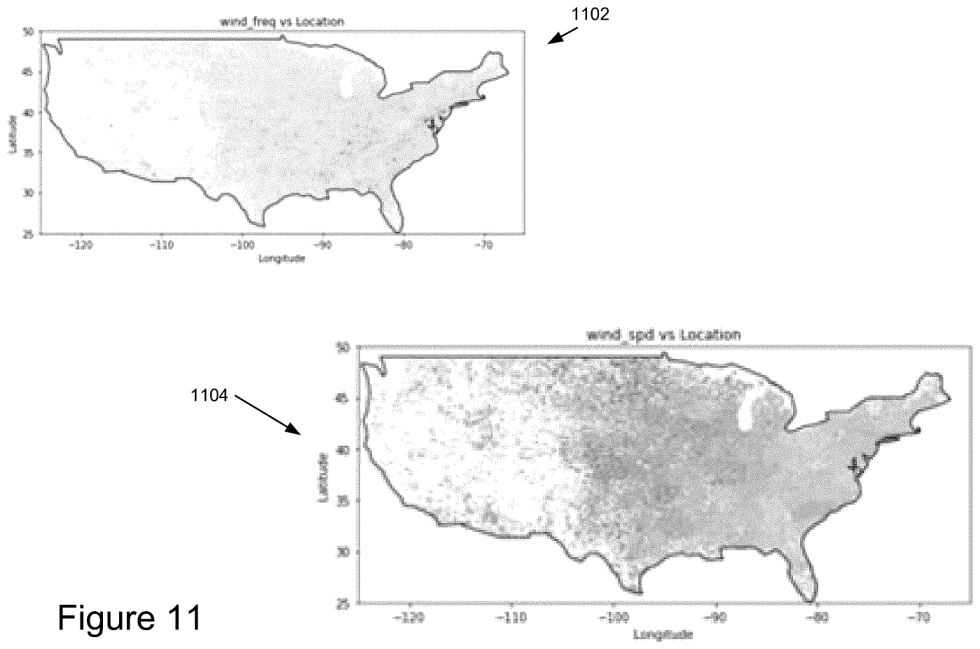

Referring now to FIG. 11, diagrams illustrative of at least some of the imbalances and missing data are provided with reference to the continental United States. Diagram 1102 illustrates a heatmap of wind report frequency for a 20-year period in the continental United States, where the darker color the higher the concentration of wind reports. As illustrated, the darker colors, and thus higher concentration of reporting generally correspond to cities, and large portions of the American West is white, which indicates data imbalances exist (e.g., East vs West and/or Urban vs Rural). Diagram 1104 illustrates a heat map of the average annual reported wind speed over a 20-year period in the continental United States, where the darker the color, the higher the average annual reported wind speed. As illustrated, substantial portions of the American West are white, indicating an absence of average annual reported wind speed data. However, it should be understood that these are merely illustrative and that different data sets (e.g., a map of max wind speed data or for different geographic regions) may have missing data and data imbalances (e.g., may appear similar-concentrated around urban centers and sparse in rural areas) that may be at least partially addressed by climatology modeler 302 and/or component(s) thereof without departing from the disclosure herein. Further it should be recognized that reference to the continental United States is for clarity and convenience and that pre-process wind data sets for other geographic regions may include imbalances and missing data analogous to those described with reference to FIG. 11.

In some implementations, the wind data set preprocessor 406 generates a gridded map of the geographic region represented in the wind data set. For example, continuing the example of the continental United States, the wind data set preprocessor 406 generates a grid dividing a map of the continental United States into, e.g., 16 km×16 km squares, and maps wind report locations to the nearest grid (e.g., by distance to grid centroid). In some implementations, wind reports from the same day and grid may be removed. For example, the report with the highest reported wind speed is kept of the group, in an implementation. In some implementations, reports from before a predetermined date (e.g., 2002) may be removed, e.g., to reduce observation bias. As a result, the wind data set preprocessor 406 may produce a distribution (e.g., gridded) of reported wind speeds for the period represented by the wind data set (e.g., 2002-2021) may be generated. The gridded distribution of reported wind speeds generated by the wind set preprocessor 406 may reduce at least some of the imbalance (e.g., by limiting one metric per grid location), and may beneficially improve modeled wind data accuracy and may also beneficially improve predictions of wind reimbursement requests, in an implementation.

The inference engine 422 may include software and/or logic to provide the functionality for making one or more inferences from the wind data set and adding the inference to the wind data set prior to model training. The types of inferences and specific inferences may vary depending on the implementation and use case. For example, in some implementations, the inference engine 422 may infer one or more of a windstorm's location, direction, and speed of the storm based on wind reports in the wind data set, e.g., by using the azimuth between two report locations as a proxy for the wind direction. Models are generated and used by the inference engine 422 to infer wind data at any coordinate in the contiguous USA. In this implementation, three models may be used to generate the modeled SPC wind data, including an average annual wind report frequency model, an average annual average reported wind speed model, and an average annual maximum reported wind speed model. Gaussian Process (GP) regression models built off of SPC data may be chosen by administrators of the climatology modeler 302 due to higher correlations with reimbursement request vs. no-reimbursement request data as well as other evaluations of the models, including an analysis of their distributions, variography to assess the noise in the data and appropriateness of using GP regression, and K-Fold cross-validation with Mean Absolute Error (MAE) and Mean Absolute Percentage Error (MAPE) as evaluation metrics. The performance of these models may be compared to a dummy classifier that simply predicts the mean of the target variable at all locations.

The normalizer 424 may include software and/or logic to provide the functionality for generating additional data during the creation and/or validation of the wind data set(s). For example, the normalizer 424 may normalize the wind data set(s) by smoothing the data to remove noise in some implementations. In geostatistics, variograms may be used as a basis of a prediction algorithm as well as used to characterize the properties of regionalized variables by the parameters such as range, nugget, sill and the variograph. In some implementations, the normalizer 424 may generate a variogram to identify the spatial relationship between neighboring points, revealing the appropriateness for Gaussian Process (GP) regression. As described above, the inference engine 422 generates and uses models to infer wind data at any coordinate in the contiguous USA by using the reported wind data at discrete data points at various locations. Because the spatially discrete data (from SPC reports) do not cover the contiguous United States, the goal of these wind data software modules, such as the inference engine 422 and the normalizer 424, is to convert the spatially discrete data into a uniform grid that covers the contiguous United States.

As an illustrative example, temperature readings may be measured across a small field. At certain coordinates in the small field, specific temperature readings may be measured, but in order to estimate the temperature at all points in the field, geostatistical techniques may be used to predict the temperature at all points in the field. Given known data points at five locations (x,y): 20 degrees Celsius at (1,1), 22 degrees Celsius at (2,2), 24 degrees Celsius at (3,3), 23 degrees Celsius at (4,4), and 21 degrees Celsius at (5,5). When using GP regression to interpolate the data, it is assumed that these temperatures are spatially related. A spatial relation specifies how some object is located in space in relation to some reference object. To what extent the temperatures are related is a question that may be answered by the variogram. A variogram would show that temperature at (1,1) is strongly correlated to temperature at (2,2) and the correlation becomes weaker as the distance increases from (1,1). At some point, the correlation would flatten out, meaning that the correlation may cease to exist or that the correlation may not change past a certain distance. Based on this information where the variogram flattens out, a mathematical formula may be generated to calculate the temperature at location (2.5, 2.5). Using simple bilinear interpolation to determine the temperature at location (2.5, 2.5), the average of the temperature values at (2,2) and (3,3) coordinates would result in the value at this new point, or 23 degrees Celsius. However, using GP regression, the value at this point will be slightly different because it is not only affected by (2,2) and (3,3), but also by the other known data points. Values at coordinates that are further away have a lesser effect than the values closer to the coordinate location where the value is being interpolated. This process is repeated for every unknown point across the contiguous US. This GP regression results in calculating the weight of all nearby known points and deriving the value of the wind variable at the unknown points. Additionally, GP regression further results in generating an uncertainty value along with the value of the wind variable.

As another example, reported wind data may exist for a particular location, such as a buoy on Lake Superior near Marquette, Michigan. Reported wind data may also exist for a nearby location, such as Big Bay, Michigan. A simple interpolation of the data, such as a bilinear interpolation, could merely take the average of the reported wind speed from the two locations. However, a more complex interpolation, such as GP regression, may result in an interpolated data value for the wind data at a location between the two locations along with an uncertainty value as expressed using a variogram model. Thus, the normalizer 424 may be used to generate this additional data to help smooth the inferred data from the inference engine 422. As described above, three models may be used to generate the modeled SPC wind data, including an average annual wind report frequency model, an average annual average reported wind speed model, and an average annual maximum reported wind speed model. Each model may be associated with a different variogram. The variogram may reveal how noisy the data is via the nugget value. The nugget is the y-intercept of the variogram which represents short-term variability in the data. The sill is the point at which the variogram appears to level off or flattens out. The difference between nearby points may be normalized by the normalizer 424 by calculating the difference between the nugget and the sill using the normalized difference:

$$d = \frac{c 0 - b}{c 0} . \qquad Equation 1$$

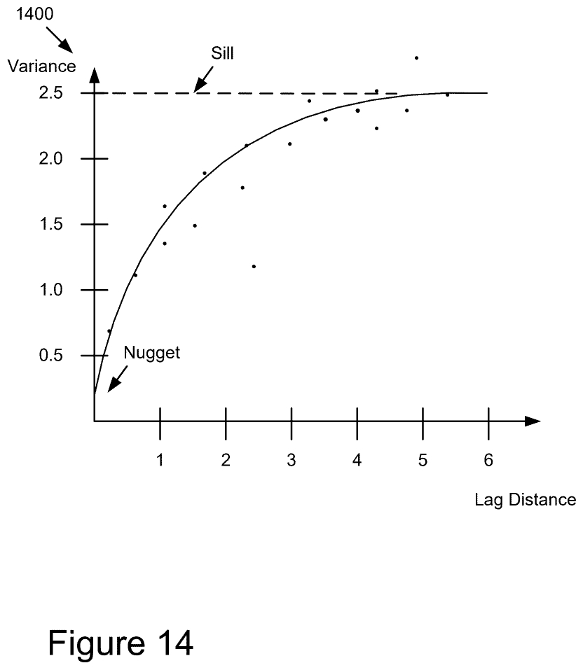

It may be expected that the difference between nearby points be, on average, less than points further away. If this is not the case, then the data may be too noisy to model well. When the nugget takes on the ideal value of 0, then d=1. As the nugget approaches the value of the sill, then d tends towards 0—which is indicative of no spatial auto-correlation. An acceptable value for d is assumed to be greater than 0.5, in an implementation. As illustrated in FIG. 14, an example variogram 1400 is shown where the nugget is the y-intercept of the fitted polynomial function, and the sill in the point on the interpolated line where the line appears to flatten out, i.e., the point where the differences between the data points stop increasing along the y-axis. Each plotted point represents the difference between a pair of known data values (i.e. the variance associated with the pair of known data values), plotted against the lag distance. The lag distance is the distance between pairs of samples used to calculate a variogram. The nugget represents the variation that exists at very small distances, in an implementation. The nugget may represent the uncertainty in measurements, in another implementation.

The aggregator 426 may include software and/or logic to provide the functionality for aggregating the pre-processed data into annual values for each year which is then averaged over the entire time-span (e.g., the 20-year period of 2002-2021), in an implementation. For example, for every year of the wind data set, reports in each grid are aggregated. The number of reports in each grid is summed. The wind speed for all reports in each grid is averaged. The maximum wind speed of all reports in each grid is recorded. Then, for each grid, these annual aggregates are further aggregated across all years. The number of reports and the wind speeds are averaged over all the years, and the maximum of all maximum annual wind speeds is recorded. In another implementation, the average maximum annual wind speed may be determined for each grid. Then, points not within the contour of the United States may be removed from the data set, in an implementation. This results in a pre-processed wind data set where locations that do not have any reports are set to 0 for the annual number of wind reports and locations that do not have wind reports also do not have associated wind speeds, thus the average annual wind speeds and average maximum wind speeds may be set to NaN (“Not a Number”). This value may be useful for interpolation via kriging, in an implementation.

The wind data modeler 408 may include software and/or logic to provide the functionality for training a wind model to determine an average wind speed, maximum wind speed, and reported wind frequency for locations without data. In some implementations, the wind data modeler 408 may determine modeled wind data set(s) describing one or more wind features such as the average wind speed, maximum wind speed, and reported wind frequency. In an implementation, modeled wind data sets may be generated for and describe wind features at locations that do not have severe wind reports, any historical reported wind data sets, sparse datasets, and/or any combination thereof. Potential approaches to solve the problem of having no data for a location include simple linear regression, K-nearest neighbors with inverse distance weighting, and GP regression (often called “kriging” in geospatial applications). A GP regression model can produce a probability distribution for the value of a point at a given location. For example, a distribution for possible wind speeds at a given latitude and longitude coordinate may be generated. The mean of the distribution may be used as an input for the GP regression model in some implementations, while in other implementations, a mode or median may be used. Additionally, an uncertainty estimate may be calculated using the standard deviation of the distribution created for the location. The GP regression model may be defined by a mean function that defines what the expected values are for any location in the prediction space and what the model defaults to when there are no neighboring readings within an objectively determined distance. The GP regression model may also be defined by a covariance function that defines the relationship between neighboring points and the point in question. The covariance function may be designed such that points close to the point in question are weighted higher than points that are farther away.

As a result, when a prediction is made, a probability distribution is returned. The mean of that distribution is based on a weighted sum of the value of the mean function at that point as well as the values of neighboring points. The weighting scheme is determined by the covariance function described above. If there are many points nearby, the mean function will not contribute much to the output, and vice versa. Variograms are used for designing GP regression models because variograms help identify the best estimator based on the spatial structure relationships in the data, according to an implementation. Various software may be used for variogram modeling, such as SKGstat, and GPyTorch for GPU accelerated inference. For example, a covariance function may be designed by plotting the distance between points against the difference in their readings using a variogram class provided by SKGstat for every point in the data set. This enables understanding how similar nearby points are relative to points further away. On the variogram, values may be binned on intervals of 50 units and averaged. This makes it possible to fit a semi-variance function that describes the spatial-relationship between the distance between points and the similarity in their readings. In an implementation, only the Gaussian semi-variance function is supported due to its ease of reparameterization required for compatibility with GPyTorch. The semi-variance function may be fitted to the variogram using three parameters to describe the semi-variance function—the nugget, the sill, and the effective range—which are all returned by the variogram after fitting. Then, the semi-variance function may be converted to the covariance function. The formulation of the Gaussian function is:

$$γ ( {x}_{i} , {x}_{j} ) = b + {C}_{0} * ( 1 - exp ( - \frac{d ( {x}_{i} , {x}_{j} ) 2}{{a}^{2}} ) . \qquad Equation 2$$

Where b=nugget, a=(effective range)/2, and c₀ is the sill. For simplicity, the nugget has been assumed to be 0 for all models. The formulation of the Radial Based Function (RBF) kernel used by GPyTorch is:

$$k ( {x}_{i} , {x}_{j} ) = a * exp ( - \frac{d ( {x}_{i} , {x}_{j} ) 2}{2 {l}^{2}} ) . \qquad Equation 3$$

The covariance function is equal to the sill minus the semi-variance function. By adding a free-parameter (a) in front of the exponential of the RBF kernel, these parameters can be easily solved for in terms of the effective range and sill, yielding the following values: b=0 (assumption of a 0 nugget, i.e. neglecting noise); a=c₀ (i.e. the sill); and l=r/(2√2). The GPyTorch RBF Kernel is wrapped with Scale Kernel, and the values are instantiated by initializing the length-scale of the RBF Kernel with the value of (and the output-scale with a.

Depending on the implementations, the mean function may be designed using one of two approaches: first, the mean function can be assumed to take a constant value (i.e., the mean of the training data) or second, trend analysis may be used for creating a mean function when the average value of the target variable is expected to vary strongly with location. For wind data, it is expected that the mean will vary by latitude and longitude. Using annualized SPC data, the United States may be divided into intervals, e.g., into 111 km intervals because 1 degree in latitude and longitude is approximately 111 km. Within each interval, the mean of the annualized values may be calculated. The mean value may then be plotted against the mean of the latitude/longitude for each interval. Then, a polynomial may be fitted to the resultant data, producing two “trend functions”-a longitudinal trend and a latitudinal trend. The inputs to these models are longitude and latitude, respectively, and the output is the annualized value (either wind report frequency, wind speed, or maximum wind speed). Thus, a custom mean function may be created by generating the average of these two models.

The models described above are trained using the wind model trainer 408 using a k-fold cross-validation approach with k=5 and performance results are recorded. After this, the model is retrained on the entirety of the dataset. Within each training session, the length-scale and free-parameter are further tuned by optimizing the marginal log likelihood.

Wind report frequency may be modeled and generated using the GP regression model that infers wind data based on SPC data, resulting in a fluid distribution of wind report frequencies, in an implementation. The average annual wind report frequency model may be evaluated using an analysis of the distribution of modeled data and correlation to reimbursement request/no-reimbursement request data, variography to assess the noise of the data and appropriateness of using GP regression, and k-fold cross-validation with mean absolute (MAE) and mean absolute percentage error (MAPE) as evaluation metrics. Performance is compared to a “dummy” classifier which simply predicts the mean of the target variable at all locations.

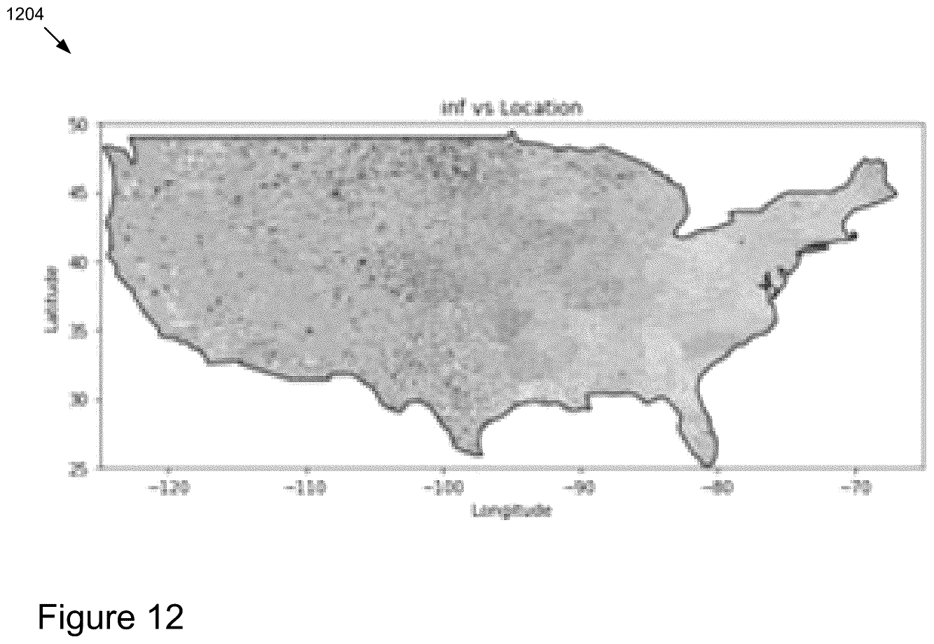

An average wind speed for any location may be determined from the average annual average reported wind speed model that separately infers wind data based on SPC data, resulting in a fluid distribution of average reported wind speeds, in an implementation. For example, referring to FIG. 12, a diagram 1204 of the modeled annual average reported wind speed within the continental United States is illustrated. As illustrated, there are no white portions (i.e. no grid portions with missing data) in contrast to diagram 1104 of FIG. 11. While not illustrated, the wind data modeler 408 may generate a maximum wind speed data describing the maximum wind speed for any location (including those without reported wind data) based on the average annual maximum reported wind speed model that separately infers wind data based on (e.g., SPC data), resulting in a fluid distribution of maximum reported wind speeds, in an implementation. Accordingly, in some implementations, the wind data modeler 408 effectively generates missing wind data for geographic regions unassociated with reported wind data.

The wind data modeler 408 may also include software and/or logic to provide the functionality for validating each wind model, in an implementation. GP regression models were found to have improved correlation with reimbursement request/no-reimbursement request data over non-modelled SPC data and the WRF data. All three GP regression models (e.g., a GP regression model for wind report frequency, an average wind speed, and a maximum wind speed) outperform a dummy classifier on MAE and MAPE, in an example implementation. Each of the models included herein were validated using various methods, including comparing performance against the dummy classifier.

The wind data modeler 408 may further include software and/or logic to provide the functionality for applying the wind model(s) trained and validated by the wind data modeler 408 to a particular location (e.g., received via user input). For example, given a latitude and longitude for a location, the wind data modeler 408 may apply one or more of three models to infer a wind report frequency, an average wind speed, and/or a maximum wind speed.

The wind speed modeler 414 obtains wind data, trains and validates one or more models based on the wind speed data, and generates one or more predictions regarding wind speed data. The wind speed modeler 414 uses the wind data set obtainer 404 to obtain wind speed data. In some implementations, the wind speed data is obtained from historical weather reports, including information describing the location of wind events, the date and time of the events, and the speed of wind recorded during those events. For example, the historical weather report data may be obtained from a data source 120 associated with a government or scientific agency that monitors and records weather events, including wind. In some implementations, the wind speed modeler 414 may extract and clean data from data sources to obtain the wind speed data used to train one or more models. For example, in some implementations, the wind speed modeler 414 may determine a latitude and longitude associated with a location described in a wind report and extract the speed of wind reported and convert the speed, if needed, into a common unit (e.g., into either miles per hour or kilometers per hour). Depending on the implementation, the wind speed modeler 414 may determine the latitude and longitude passively, e.g., by receiving a latitude and longitude in the report, or actively, e.g., by converting a location represented by another geographic coordinate system (e.g., a Universal Transverse Mercator based coordinate system) or a street address into a latitude and longitude.

The wind speed modeler 414 trains one or more wind speed models to predict wind speed. The varieties of supervised, semi-supervised, unsupervised, reinforcement learning, topic modeling, dimensionality reduction, meta-learning, and deep learning machine learning algorithms, which may be used to generate the one or models to predict wind speed are so numerous as to defy a complete list. Examples of algorithms include, but are not limited to, a decision tree; a gradient-boosted tree, a gradient-boosted machine; boosted stumps; a random forest; a support vector machine; a neural network (e.g., convolutional and/or recurrent); logistic regression (with regularization), linear regression (with regularization); stacking; a Markov model; support vector machines; and others.

In some implementations, the wind speed modeler 414 trains a Gaussian process regression model that takes a location (e.g., in the form of a latitude and longitude) as an input and outputs a wind speed (e.g., an average wind speed and/or a maximum wind speed depending on the implementation). However, it should be recognized that the disclosure herein is not limited to implementations using a Gaussian process regression model, and other artificial intelligence or machine learning algorithms may be used. For example, while a regression model may output a continuous value (e.g., the speed of an average wind event in kilometers per hour), some implementations may bin average wind speed and use a classifier, thereby outputting a class of average wind speed. Examples of classes may include, by way of example, and not limitation small/medium/large, non-damaging/minor damaging/damaging/severely damaging since the average speed of the wind event may correlate with its potential to cause damage or others. It should be recognized that the number of classes, their names, etc., may vary without departing from the disclosure herein.

In some implementations, the wind speed modeler 414 retrains one or more wind speed models. For example, the wind speed modeler 414 may retrain the one or more wind speed models annually to incorporate the preceding year's wind speed data in some implementations. In some implementations, batch, mini-batch, or online training may be performed as new wind speed data becomes available. In some implementations, the wind speed modeler 414 may retrain to maintain a rolling window of a predetermined number of preceding years (e.g., 5, 10, 20, or 50 years) to discount stale data and more closely track more recent weather phenomena.

In some implementations, the wind speed modeler 414 validates one or more wind speed models trained. For example, in some implementations, the wind speed modeler 414 may hold out data for a year (or another period) from the wind speed data when training and comparing that held-out portion of the wind speed data to the output of one or more wind speed models to confirm the accuracy of the one or more wind speed models.

In some implementations, the wind speed modeler 414, when put into production, receives a location (e.g., in latitude and longitude or converted, by the wind speed modeler 414, into latitude and longitude) and outputs a predicted wind speed or category of wind speed. The wind speed modeler 414 is communicatively coupled to other components of one or more of the climatology modeler 302, the wind predictor 220, or components thereof. For example, in some implementations, the wind speed modeler 414 is communicatively coupled to send to, or store for retrieval by, one or more of the damage frequency modeler 304 and the damage severity modeler 306, the predicted wind speed(s) and/or category(ies) thereof.

The wind report frequency modeler 416 obtains wind report frequency data, trains, validates one or more wind report frequency models based on the wind report frequency data, and generates one or more predictions regarding wind report frequency. The wind report frequency modeler 416 obtains wind report frequency data that has been either modeled or reported. In some implementations, at least a portion of the wind report frequency data is obtained from the same data set as the wind speed data. For example, the wind report frequency modeler 416 obtains wind report frequency data from historical weather reports, including information describing the location of wind events, the date and time of the events, and the speed of wind recorded during those events. In some implementations, the wind report frequency modeler 416 may extract and clean data from data sources to obtain the wind report frequency data used to train one or more wind report frequency models. For example, in some implementations, the wind speed modeler 414 may determine a latitude and longitude associated with a location described in a wind report and extract the timing (e.g., time and date) of the event.

In some implementations, the wind report frequency modeler 416 validates one or more wind report frequency models trained on modeled data. For example, in some implementations, the wind report frequency modeler 416 may hold out data for a particular year (or another period) from the wind data when training and comparing that held-out portion of the wind data to the output of one or more wind report frequency models to confirm the accuracy of the one or more wind report frequency models.

Depending on the implementation, the wind report frequency modeler 416 may model and predict an absolute frequency of wind reports, i.e., a frequency of any wind, a wind “of interest” frequency, i.e., a frequency of a wind event with wind above some minimum speed threshold (e.g., a minimum speed to cause damage to a roof and/or vehicle), or a combination thereof. In some implementations, the wind report frequency modeler 416 may predict the frequency of wind report above (or below) a certain speed.

In some implementations, the wind report frequency modeler 416, when put into production, receives a location (e.g., in latitude and longitude or converted to latitude and longitude) and outputs a predicted wind report frequency or category thereof. The wind report frequency modeler 416 is communicatively coupled to other components of one or more of the climatology modeler 302, the wind predictor 220, or components thereof. For example, in some implementations, the wind report frequency modeler 416 is communicatively coupled to send to, or store for retrieval by, one or more of the damage frequency modeler 304 and the damage severity modeler 306, the predicted wind report frequency(ies) and/or category(ies) thereof.

In FIG. 5, a block diagram of an example damage frequency modeler 304 is illustrated in accordance with some implementations. In the illustrated implementation of FIG. 5, the damage frequency modeler 304 includes a damage frequency model feature determiner 502, a damage frequency model trainer 504, a validation engine 506, and a model executer 508. The damage frequency model 304 may generate a damage frequency metric that is a score from 0 to 1 that indicates the likelihood of a wind-related damage frequency occurring.

The damage frequency model feature determiner 502 obtains feature data describing one or more features of one or more locations. The feature data describing one or more features of one or more locations obtained by the damage frequency model feature determiner 502 may be used during the validation and training of one or more feature models (e.g., by the damage frequency model trainer 504 and validation engine 506, respectively). The feature data describing one or more features of one or more locations obtained by the damage frequency model feature determiner 502 may be used during runtime to predict a damage frequency (e.g., by model executer 508).

The feature data and features represented by the feature data may vary depending on the implementation. Examples of features may include, but are not limited to, a roof resilience score, a number of roof penetrations which indicates the number of items on the roof that constitutes as a break in the roof's surface (e.g., box vents, chimneys, sky lights, etc.), a vegetation density, a roof quality and its associated reasons (e.g., the reasons for the roof quality designation (such as missing shingles, patched shingles, tarps, wear, etc.), a land cover code, a temperature, a precipitation metric, a wind report frequency, etc. However, it should be recognized that other and different features, as well as combinations and permutations thereof, are contemplated and within this disclosure.

The roof resilience score feature data may, in some implementations, represent a score from 1 to 5 with higher scores indicating higher roof resilience. The roof resilience score may represent the fraction of the current durability of the roof compared to its original durability, where durability may be calculated using properties of the roof such as the roof material and the associated expected life of the roof. For example, a roof constructed with wood materials may have a different expected life compared to a roof constructed with tiles. The expected life of a roof may be used to derive the current durability of the respective roofs and then converted to a roof resilience score using a mathematical transformation (e.g., binning).

The vegetation density feature data may, in some implementations, represent one or more of a portion of a structure (or its roof) shielded by overhanging vegetation and a portion of a surrounding area that includes vegetation. For example, a portion of an area within X feet of the perimeter of a structure's roofline to determine a portion of vegetation “near,” i.e., within X feet of the structure and/or overhanging the structure. The threshold may vary depending on the implementation and use case, e.g., X may be 5, 10, 20, 30, 40, 50, or other values. The threshold may also be measured in different units, such as meters, depending on the implementation. Depending on the implementation, the vegetation density may be continuous (e.g., a percentage) or discrete (e.g., bins having a range of density percentages or categories such as none/low/medium/high).

The roof quality feature data and its associated reasons (e.g., the reasons for the roof quality designation (such as missing shingles, patched shingles, tarps, wear, etc.) may, in some implementations, represent the condition of a structure's roof. In some implementations, the roof condition may include conditions including, but not limited to, one or more of new, good, light wear, heavy wear, minor damage, major damage, and unknown. However, other and different roof conditions such as presence of missing shingles or presence of stained shingles, including using more or fewer, are considered and may be used without departing from the disclosure herein.

The land cover code feature data may, in some implementations, represent a type of land cover at a location (e.g., high-density urban, suburban, rural, etc.). The temperature feature data may, in some implementations, represent one or more of a minimum, maximum, or average temperature, e.g., annually and/or during a wind season. The precipitation feature data may, in some implementations, represent one or more types of precipitation (e.g., rain, snow, etc.) and/or one or more metrics (e.g., a minimum, maximum, or average precipitation) and may describe different time periods (e.g., annually and/or during a season associated with the type or precipitation). The wind frequency feature data may, in some implementations, represent a frequency of an occurrence of wind, e.g., one or more of the frequency of wind event occurring (at all) and the frequency of a wind event that has the potential to cause damage (e.g., above a threshold speed of wind) occurring.

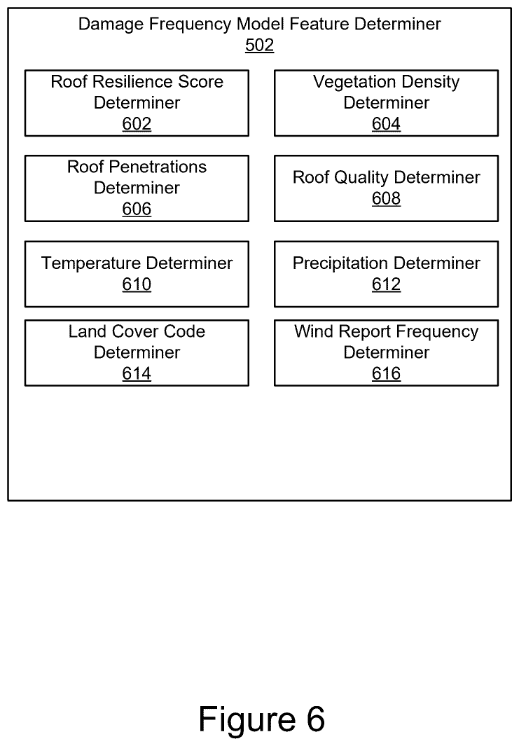

Referring now to FIG. 6, an example damage frequency model feature determiner 502 is illustrated according to one implementation. In the illustrated implementation of FIG. 6, the damage frequency model feature determiner 502 includes a roof resilience score determiner 602, a roof penetrations determiner 606, a vegetation density 604, a roof quality (and its associated reasons (e.g., the reasons for the roof quality designation (such as missing shingles, patched shingles, tarps, wear, etc.)) determiner 608, a temperature determiner 610, a precipitation metric determiner 612, a land cover code determiner 614, and a wind report frequency determiner 616. In some implementations, the subcomponents 602/604/606/608/610/612/614/616 of the feature determiner 502 each obtain its respectively identified feature data. For example, the roof quality determiner 608 obtains roof quality feature data. The vegetation density determiner 604 obtains vegetation density feature information, the roof penetrations determiner 606 obtains roof penetrations feature data, the temperature determiner 610 obtains temperature feature data, the precipitation metric determiner 612 obtains precipitation metric feature data, the land cover code determiner 614 obtains land cover code feature data, and the wind report frequency determiner 616 obtains wind report frequency data from one or more components in the climatology modeler 302.

Depending on the implementation and use case, the mechanism by which the damage frequency model feature determiner 502 or subcomponent 602/604/606/608/610/612/614/616 thereof obtains the feature data may vary. In some implementations, the damage frequency model feature determiner 502 or subcomponent(s) 602/604/606/608/610/612/614/616 thereof obtain the feature data “passively”, i.e., the feature determiner 502 does not actively generate, calculate, or determine the feature data but receives or reads the data. For example, feature data may be received or read from a data source 120. For example, one or more of a roof resilience, a number of roof penetrations, a vegetation density, a roof quality, may be obtained passively (e.g., by the roof resilience score determiner, vegetation density determiner, roof quality determiner respectively) from records such as county building records, or records generated from human inspection and/or measurement. As another example, one or more of the temperature, precipitation metric, and land cover code may be obtained passively (e.g., by the temperature determiner, precipitation determiner, and land cover code determiner, respectively) from weather and/or geographic survey data. As another example, the wind report frequency determiner 616 is communicatively coupled to receive or retrieve, the average wind frequency determined by the wind report frequency modeler 416, and the average wind speed determiner is communicatively coupled to receive, or retrieve, the average wind speed determined by the wind speed modeler 414.

In some implementations, the damage frequency model feature determiner 502 or subcomponent(s) 602/604/606/608/610/612/614/616 thereof obtain the feature data “actively,” i.e., the damage frequency model feature determiner 502 generates, calculates, or determines the feature data. For example, the wind report frequency determiner 616 includes an instance of the wind frequency modeler 416 and the average wind speed determiner 618 includes an instance of the wind speed modeler 414. As another example, one or more of: the vegetation density determiner obtains an aerial image of the location and uses a vegetation density model to determine the vegetation density; the roof material determiner obtains an aerial image of the location and uses a roof material determination model to determine a roof material; and the roof quality determiner obtains an aerial image of the location and uses a roof quality model to determine a roof quality.

In some implementations, one or more of the vegetation density determiner, roof material determiner, and the roof quality determiner use machine learning models applied to and trained on, one or more aerial images (e.g., RGB aerial or satellite images, DSM images, etc.). The varieties of supervised, semi-supervised, unsupervised, reinforcement learning, topic modeling, dimensionality reduction, meta-learning and deep learning machine learning algorithms, which may be used to generate those models, are so numerous as to defy a complete list. Examples of algorithms include, but are not limited to, a decision tree; a gradient-boosted tree, gradient-boosted machine; boosted stumps; a random forest; a support vector machine; a neural network (e.g., convolutional and/or recurrent); logistic regression (with regularization), linear regression (with regularization); stacking; a Markov model; support vector machines; and others. In some implementations, vegetation density determiner, roof material determiner, and the roof quality determiner use machine learning models applied to, and trained on, one or more aerial images (e.g., RGB aerial or satellite images, DSM images, etc.).

During training, the damage frequency model feature determiner 502 obtains feature data describing one or more features for various properties included in the training data. During runtime, the damage frequency model feature determiner 502 obtains feature data describing one or more features of a property, or structure, at a received location. For example, the damage frequency model feature determiner 502 receives a location, such as an address of interest or a latitude and longitude and obtains feature data describing one or more features of a structure at the location, such as a building (or roof) area, vegetation density, roof material, roof quality, temperature, precipitation metric, average wind frequency, average wind speed, etc. at the requested location. In some implementations, the damage frequency model feature determiner 502, or one or more subcomponents, obtain one or more aerial images (e.g., DSM and RGB images) and derive data describing one or more features by applying one or more models (e.g., one or more convolutional neural networks) to the one or more images). The derived data may describe the one or more features, including, but are not limited to, a roof resilience score, a number of roof penetrations which indicates the number of items on the roof that constitutes as a break in the roof's surface (e.g., box vents, chimneys, sky lights, etc.), a vegetation density, a roof quality and its associated reasons (e.g., the reasons for the roof quality designation (such as missing shingles, patched shingles, tarps, wear, etc.), a land cover code, a temperature, a precipitation metric, a wind report frequency, etc.

The damage frequency model feature determiner 502 and its subcomponents are communicatively coupled to other components of one or more of the damage frequency modeler 304, the wind predictor 220, or components thereof. For example, in some implementations, the feature determiner 502 is communicatively coupled to send to, or store for retrieval by, one or more of the damage frequency model trainer 504 and validation engine 506, the feature data for training and validation. As another example, in some implementations, during runtime, the damage frequency model feature determiner 502 is communicatively coupled to, sent to, or stored for retrieval by, the model executer 508, the feature data for the application of the damage frequency model.

Referring again to FIG. 5, the damage frequency model trainer 504 trains one or more damage frequency models. The varieties of supervised, semi-supervised, unsupervised, reinforcement learning, topic modeling, dimensionality reduction, meta-learning and deep learning machine learning algorithms, which may be used to generate the one or models to predict wind frequency, are so numerous as to defy a complete list. Examples of algorithms include, but are not limited to, a decision tree; a gradient-boosted tree, gradient-boosted machine; boosted stumps; a random forest; a support vector machine; a neural network; logistic regression (with regularization), linear regression (with regularization); stacking; a Markov model; support vector machines; and others.

In some implementations, the damage frequency model trainer 504 trains a machine learning model that takes a location (e.g., in the form of latitude and longitude) and property having defined features as an input and outputs a frequency or probability of a wind event causing damage at the property at that location. The model may be measured using an F1 score to understand the overall and class-wise performance. The F1 score is the harmonic mean of precision and recall of the model. Precision may measure how many retrieved items are relevant. Recall may measure how many relevant items are retrieved. Additional metrics may be included to explain the distribution of predicted probabilities (e.g., gini coefficient and probability calibration) and the tradeoff of False Positive (FP)/True Positive (TP) for given thresholds (e.g., Area Under Curve (AUC)). The receiver operating characteristic (ROC) is a chart that visualizes the tradeoff between true positive rate (TPR) and false positive rate (FPR). For every threshold, one can calculate the TPR and FPR and plot it on one chart. The higher the TPR and lower the FPR is for each threshold indicates a better classifier such that curves that are more top-left side are better. Thus, the ROC AUC may be calculated to evaluate the model. As more iterations of the model are produced, the models may be compared to see the change in TPR and FPR. It should be recognized that the disclosure herein is not limited to implementations using a Gaussian process regression model and other artificial intelligence or machine learning algorithms may be used. For example, while a regression model may output a continuous value (e.g., the frequency of wind events or probability of a wind event occurring within a particular time period), some implementations may bin the frequency (e.g., “reimbursement request” if the probability of a wind reimbursement request occurring is ≥50% else “no reimbursement request”) or use a classifier, thereby outputting a class of wind frequency. Examples of classes may include, by way of example and not limitation, high/medium/low, no wind/low frequency/moderate frequency/high frequency/very high frequency, reimbursement request/no reimbursement request, etc. It should be recognized that the number of classes, their names, etc., may vary without departing from the disclosure herein.

In some implementations, damage frequency model trainer 504 retrains one or more wind frequency models. For example, the damage frequency model trainer 504 may retrain annually to incorporate the preceding year's wind data in some implementations. In some implementations, batch, mini-batch, or online training may be performed as new wind data becomes available. In some implementations, the damage frequency model trainer 504 may retrain to maintain a rolling window of a predetermined number of preceding years (e.g., 5, 10, 20, or 50 years) to discount stale data and more closely track more recent weather phenomena.

The damage frequency model trainer 504 uses training data to train one or more wind frequency models. In some implementations, the damage frequency model trainer 504 prepares the training data, which includes data describing properties that experienced wind damage and properties that did not experience wind damage. For example, in some implementations, the damage frequency model trainer 504 identifies the first set of properties that experienced wind damage from one or more of insurance reimbursement request information (e.g., wind reimbursement requests) and/or building permit data (e.g., building permits for roof repair and/or replacement where the permit indicates wind as a cause or contributory reason). For example, in some implementations, the damage frequency model trainer 504 identifies a second set of properties that did not experience wind damage from one or more of from insurance reimbursement request information (e.g., non-wind reimbursement requests), properties in areas where wind is uncommon (e.g., Utah, Idaho, etc.), and randomly selected properties cross-referenced to confirm that the properties did not incur wind damage.

In some implementations, the damage frequency model trainer 504 may obtain the locations and feature data (e.g., via the feature determiner 502) for each property in the training data set to generate the training data on which one or more damage frequency models. In some implementations, further filtering and cleaning of the training data may be done by the damage frequency model trainer 504, e.g., to eliminate a type or limit a type of structure (e.g., eliminate buildings under construction, or non-single-family homes, or properties that satisfy a threshold). Examples of such thresholds may include, but are not limited to, roof sizes that exceed a maximum threshold or do not meet a minimum threshold, etc.

The validation engine 506 validates one or more damage frequency models trained. For example, in some implementations, the validation engine 506 may hold out data for a particular area (e.g., a city, state, or region) when training and comparing that held-out portion of the wind data to the output of one or more damage frequency models to confirm the accuracy of the one or more models. As another example, in some implementations, the validation engine 506 may hold out data for a particular year (or another period of time) when training and comparing that held-out portion to the output of one or more damage frequency models to confirm the accuracy of the one or more models.

In some implementations, the damage frequency model trainer 504 and validation engine 506 may perform feature selection. In some implementations, during feature selection, different features or sets of features may be eliminated, and a performance of the resulting (e.g., trained and validated) model instances may be compared to one another (e.g., by comparing F1 scores or other performance metric(s)). Based on a performance comparison, in some implementations, a model with a reduced feature set may perform better, as well, or nearly as well as a model with a larger feature set. In some implementations, the model with the reduced feature set is selected for application by the model executor 508.

The model executer 508 applies one or more damage frequency models and presents a resulting damage frequency. For example, during runtime, the model executer 508 receives a location, obtains feature data associated with the received location from the feature determiner 502, and applies one or more damage frequency models. In some implementations, the feature data includes data describing one or more of: one or more weather features (e.g., wind frequency, average amount of annual precipitation, average temperature, etc.) and one or more features of a property at the location (e.g., any of the aforementioned property and/or structural features, such as roof condition, vegetation density, etc.).

The model executer 508 is communicatively coupled to send, or store for retrieval, the damage frequency. For example, in some implementations, the model executer 508 may be coupled to one or more of the damage severity modeler 306 and the decision engine 308. In another example, the model executer 508 is communicatively coupled to present the damage frequency (e.g., display the damage frequency associated with the received location).

Referring again to FIG. 3, the damage severity modeler 306 trains, validates, and applies one or more damage severity models. In some implementations, during training, the damage severity modeler 306 uses training data describing a plurality of properties that experienced wind damage. Depending on the implementation, the plurality of properties that experienced wind damages may be obtained from one or more of the reimbursement requests data, including properties that submitted a reimbursement request for wind damage and building permit data where permits (e.g., for roof repair or replacement) identify wind as the cause or contributory reason.

In some implementations, the training data used by the damage severity modeler 306 includes, for each described property that experienced damage, one or more damage values associated with the property that experienced wind damage, one or more weather features associated with the property that experienced wind damage, and one or more specific attributes, or features, associated with the property, or a structure on the property. Examples of damage values may include but are not limited to a number of roof squares (e.g., damaged, replaced, reimbursement requested, etc.), a square footage (e.g., damaged, replaced, reimbursement requested, etc.), a replacement cost, replacement cost as a percentage of coverage amount, etc. In some implementations, a roof square is 10 square feet. Examples of weather features associated with a property include one or more of a temperature (average, variation), a precipitation measure (e.g., number of inches or occurrences annually), a wind frequency, a wind speed, etc. Examples of specific attributes, or features, associated with the property, or a structure on the property, may include, but are not limited to, one or more of a building (or roof) area, an overhead vegetation density, a roof material, a roof quality, a roof pitch, a roof height, a roof shape.

In an implementation, some features may be identified to be more predictive in the damage frequency and/or damage severity model. For example, the effect of overhead vegetation density may be found to be opposite than expected, where high vegetation density is more associated with no-reimbursement requests than with reimbursement requests. Additionally, temperature, wind speed, and wind report frequency may be found to be the most important continuous variables. In an implementation, roof quality and its associated reasons (e.g., the reasons for the roof quality designation (such as missing shingles, patched shingles, tarps, wear, etc.), mean temperature and roof resilience score are features that are found to be correlated to the damage frequency model, with roof quality having the strongest feature having a monotonic relationship with the likelihood of a reimbursement request. Furthermore, through an ablation study that tests the impact of removing a feature on a model, wind frequency, precipitation, roof penetrations, vegetation density, and land cover were found to improve performance of the damage frequency model.

Depending on the implementation, the features represented in training data for the damage frequency model and the damage severity model may vary in their degree of similarity. For example, the training data for the damage frequency model and the damage severity model may or may not be mutually exclusive. In implementations where the training data for the damage frequency model and the damage severity model are not mutually exclusive, their degree of similarity may vary, depending on the implementation and use case, in the number of damage values and/or weather features and/or property features commonly represented in both sets of training data.

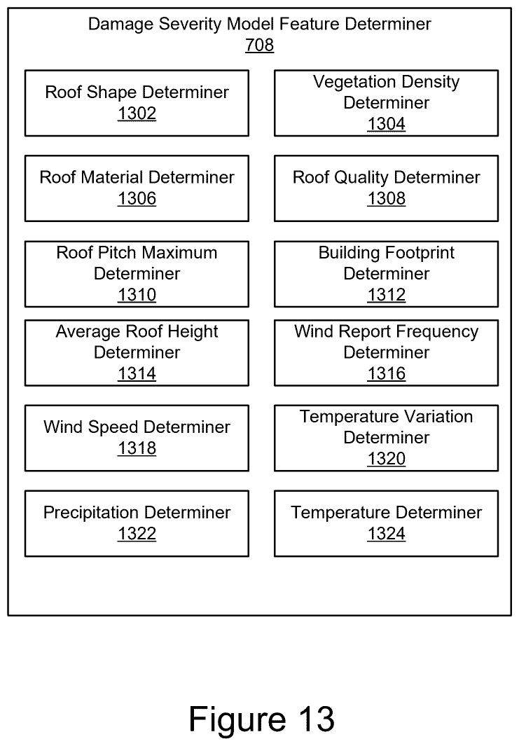

In some implementations, the damage severity modeler 306 may include a damage severity model feature determiner 708 for obtaining feature data including, e.g., one or more of at least one damage value, at least one weather feature, and at least one feature during training and/or runtime, as shown in FIG. 7. In some implementations, the damage severity modeler 306 may include a feature determiner analogous to damage frequency model feature determiner 502, discussed above with reference to FIG. 6, or analogous to one or more components of damage frequency model feature determiner 502. In some implementations, the damage severity modeler 306 may be communicatively coupled to and use the damage frequency model feature determiner 502 or one or more subcomponents thereof. In other implementations, the damage severity modeler 306 includes a damage severity model feature determiner 708 for obtaining feature data as input for the damage severity model. As shown in FIG. 13, the damage severity model feature determiner 708 includes a roof shape determiner 1302 that indicates the shape of the roof (i.e., hip, gable, flat, etc.), a vegetation density determiner 1304 that indicates the percentage of the roof area covered by overhanging vegetation, a roof material determiner 1306 that indicates the type of material on the surface of the roof (i.e., composite shingle, wood, tile, metal, etc.), a roof quality determiner 1308 that indicates a roof quality score (similar to or same as in the damage frequency model feature determiner 502), a roof pitch maximum determiner 1310 that indicates the maximum slope of the roof, a building footprint determiner 1312 that indicates the area contained in the building footprint on a two-dimensional scale, an average roof height determiner 1314 that indicates the mean vertical distance between the roof and the ground, a wind report frequency determiner 1316 (same as determined by the damage frequency model feature determiner 502), a wind speed determiner 1318 (same as determined by the damage frequency model feature determiner 502), a temperature variation determiner 1320 that indicates, for example, a 30-year mean range of temperatures experienced by a given location (e.g., 1991-2020), a precipitation determiner 1322 (same as determined by the damage frequency model feature determiner 502), and a temperature determiner 1324 (same as determined by the damage frequency model feature determiner 502).

In some implementations, one or more features are encoded. For example, roof materials composite shingle, tile, slate, metal, flat roof material, wood, mixed, and others may be encoded as 0, 1, 2, 3, 4, 5, 6, and 7, respectively. As another example, the roof shapes hip, hip-gable, gable, flat, and other may be encoded as 0, 1, 2, 3, and 4, respectively. As another example, solar panels=yes and solar panels=no may be encoded as 0 and 1, respectively. As yet another example, the roof qualities of good, light wear, heavy wear, minor damage, major damage, and bad image may be encoded as 0, 1, 2, 3, 4, and NaN, respectively. It should be recognized that these are merely examples of encodings and categories that are encoded, and variations are contemplated and within the scope of this disclosure.

In some implementations, the damage severity modeler 306 may include a damage severity feature determiner 708 that uses feature data describing specific attributes, or features, associated with a property to train the damage severity model(s) and predict a damage severity from wind events associated with a received location. For example, specific attributes or features associated with a property may include, but are not limited to, a building area, a vegetation density, a roof material, a roof quality, a roof pitch, a roof height, a roof shape, a land cover code, a temperature, a precipitation metric, a wind report frequency, a wind speed, etc. As shown in FIG. 13, the damage severity model feature determiner 708 includes a roof shape determiner 1302 that indicates the shape of the roof (i.e., hip, gable, flat, etc.), a vegetation density determiner 1304 that indicates the percentage of the roof area covered by overhanging vegetation, a roof material determiner 1306 that indicates the type of material on the surface of the roof (i.e., composite shingle, wood, tile, metal, etc.), a roof quality determiner 1308 that indicates a roof quality score (similar to or same as in the damage frequency model feature determiner 502), a roof pitch maximum determiner 1310 that indicates the maximum slope of the roof, a building footprint determiner 1312 that indicates the area contained in the building footprint on a two-dimensional scale, an average roof height determiner 1314 that indicates the mean vertical distance between the roof and the ground, a wind report frequency determiner 1316 (same as determined by the damage frequency model feature determiner 502), a wind speed determiner 1318 (same as determined by the damage frequency model feature determiner 502), a temperature variation determiner 1320 that indicates, for example, a 30-year mean range of temperatures experienced by a given location (e.g., 1991-2020), a precipitation determiner 1322 (same as determined by the damage frequency model feature determiner 502), and a temperature determiner 1324 (same as determined by the damage frequency model feature determiner 502).

Depending on the implementation and use case, a damage value may be a raw value (e.g., a replacement/repair cost of 0.12 (or 12%) of primary building coverage value) or a binned range of replacement/repair cost as a percentage of primary building coverage value. The number of bins and associated ranges may vary depending on the implementation and use case.

The damage severity modeler 306 trains one or more damage severity models. The varieties of supervised, semi-supervised, unsupervised, reinforcement learning, topic modeling, dimensionality reduction, meta-learning and deep learning machine learning algorithms, which may be used to generate the one or models to predict wind frequency, are so numerous as to defy a complete list. Examples of algorithms include, but are not limited to, a decision tree; a gradient-boosted tree, gradient-boosted machine; boosted stumps; a random forest; a support vector machine; a neural network; logistic regression (with regularization), linear regression (with regularization); stacking; a Markov model; support vector machines; and others.

Depending on the implementation and use case, it may be preferable to have the damage severity output as a continuous variable (e.g., roof squares, expected loss, expected loss to primary building coverage value, etc.) or as a discrete variable (e.g., a plurality of bins associated with different ranges of roof squares, expected loss to primary building coverage value, etc.) or a classifier (high/medium/low). It should be recognized that other numbers of classes, class names, bins, and associated ranges, etc., are contemplated and may be used without departing from the disclosure herein. For clarity and convenience, a regression (continuous variable output) implementation and a classifier (discrete variable output) implementation are discussed with reference to FIG. 7.

Referring now to FIG. 7, a block diagram of an example damage severity modeler 306 is illustrated in accordance with some implementations. In the illustrated implementation of FIG. 7, the damage severity modeler 306 includes a severity classifier 702, a severity regression modeler 704, a severity calculator 706, and a damage severity model feature determiner 708. In some implementations, the severity calculator 706 is optional and may be omitted.

The severity classifier 702 trains, validates, and tests one or more damage severity classification models. The classification algorithm used by the severity classifier 702 may vary based on the implementation and use case. In some implementations, the severity classifier 702 uses a gradient-boosted machine algorithm. In some implementations, the severity classifier 702 performs an 80/20 split (i.e., it uses 80% of data available for training and 20% for validation). In some implementations, the severity classifier 702 performs an optimization using Bayesian optimization, but other optimizations may be used.

The severity regression modeler 704 trains, validates, and tests one or more damage severity regression models. The regression algorithm used by the severity regression modeler 704 may vary based on the implementation and use case. In some implementations, the severity regression modeler 704 uses a gradient-boosted machine algorithm. In some implementations, the regression modeler 704 performs an 80/20 split (i.e., uses 80% of data available for training and 20% for validation). In some implementations, the severity regression modeler 704 determines an information gain associated with each feature used in the model.

In some implementations, one or more features may be eliminated from a damage model. For example, one or more of a feature with a gain below a threshold or a feature outside the X features with the highest gain may be eliminated. Such feature reduction may beneficially expedite training and execution of the associated model while minimizing adverse effects on accuracy.

In some implementations, damage severity modeler 306 retrains one or more damage severity models. For example, the damage severity modeler 306 may retrain annually to incorporate the preceding year's wind data in some implementations. In some implementations, batch, mini-batch, or online training may be performed as new data becomes available. In some implementations, the damage severity modeler 306 may retrain to maintain a rolling window of a predetermined number of preceding years (e.g., 5, 10, 20, or 50 years) to discount stale data and more closely track more recent weather phenomena.

In some implementations, the damage severity modeler 306 may obtain the locations and feature data (e.g., via the damage severity model feature determiner 708) for each property in the training data set to generate the training data on which one or more damage severity models. In some implementations, further filtering and cleaning of the training data may be done by the damage severity modeler 306, e.g., to eliminate a type or limit a type of structure (e.g., eliminate buildings under construction, or non-single-family homes, or properties that satisfy a threshold). Examples of such thresholds may include, but are not limited to, roof sizes that exceed a maximum threshold or do not meet a minimum threshold, etc.

The damage severity modeler 306 validates one or more damage severity models trained. For example, in some implementations, the damage severity modeler 306 may hold out data for a particular area (e.g., a city, state, or region) from the wind data when training and comparing that held-out portion of the wind data to the output of one or more wind size models to confirm the accuracy of the one or more models. As another example, in some implementations, the damage severity modeler 306 may hold out data for a particular year (or another period of time) from the wind data when training and comparing that held-out portion of the wind data to the output of one or more wind damage severity models to confirm the accuracy of the one or more models.

The damage severity modeler 306 applies one or more damage severity models and presents a resulting damage severity. For example, during runtime, the damage severity modeler 306 receives a location, obtains feature data associated with the received location, and applies one or more damage severity models. In some implementations, the feature data includes data describing one or more of: one or more weather features (e.g., an average wind speed, wind frequency, precipitation metric, average temperature, etc.) and one or more features of a property at the location (e.g., property and/or structural features, such as building area, roof material, roof shape, roof quality, vegetation density, roof pitch, roof height, etc.).

The damage severity modeler 306 is communicatively coupled to send or store for retrieval, a data metric for the damage severity. For example, in some implementations, the damage severity modeler 306 may be coupled to one or more of the damage frequency modeler 304 and the decision engine 308. In another example, the damage severity modeler 306 is communicatively coupled to present a data metric for the damage frequency (e.g., display data representing the damage frequency associated with the received location).

The severity calculator 706 may perform one or more calculations based on an output from the severity classifier 702 and/or regression modeler 704 to compute a cost metric for the damage severity. For example, the severity calculator 706 may obtain the damage severity from the damage severity modeler 306, perform one or more calculations, and present the results. For example, in some implementations, the severity modeler 306 outputs the damage severity as a number of roof squares expected to be damaged and/or magnitude of reimbursement requested. The severity calculator 706 may perform calculations based on that output, such as the cost of replacement, expected loss, expected loss as a percentage of primary building's insurance coverage value, estimated quantity of materials, estimated labor charges, estimated delivery fees, estimated labor costs, and annual average work value, which may account for inflation, etc.

### Example Methods

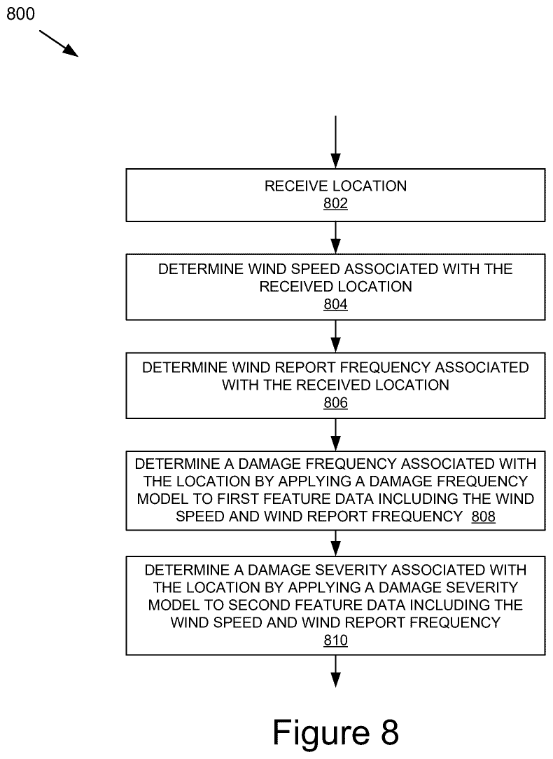

FIGS. 8-10 are flowcharts of example methods that may, in accordance with some implementations, be performed by the systems described above with reference to FIGS. 1-7. The methods of FIGS. 8-10 are provided for illustrative purposes, and it should be understood that many variations exist and are within the scope of the disclosure herein.

FIG. 8 is a flowchart of an example method 800 for making one or more wind predictions in accordance with some implementations. At block 802, the wind predictor 220 receives a location. At block 804, the climatology modeler 302 determines a wind speed associated with the location using a first wind machine learning model. At block 806, the climatology modeler 302 determines a wind report frequency associated with the location using a first wind report frequency machine learning model. At block 808, the damage frequency modeler 304 determines a damage frequency associated with the location by applying a first damage frequency machine learning model to the first feature data, including the wind speed and wind report frequency. At block 810, the damage severity modeler 306 determines a damage severity associated with the location by applying a first damage severity machine learning model to second feature data, including the wind speed and wind report frequency.

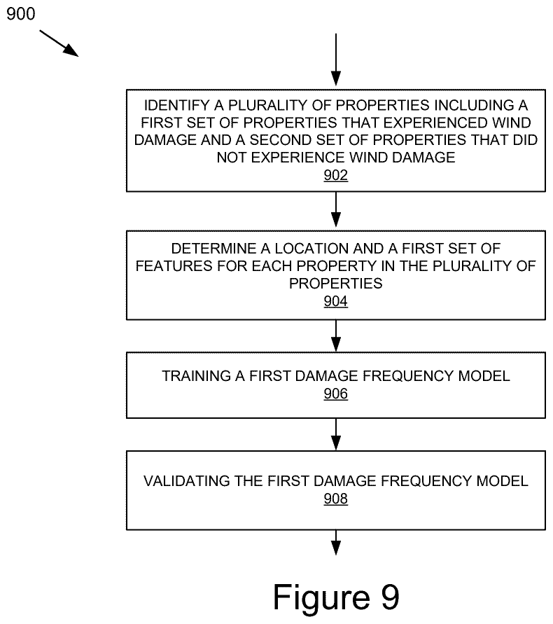

FIG. 9 is a flowchart of an example method 900 for training frequency of damage model(s) in accordance with some implementations. At block 902, the damage frequency modeler 304 identifies a plurality of properties, including a first set of properties that experienced wind damage and a second set of properties that did not experience wind damage. At block 904, the feature determiner 502 determines a location and the first set of features for each property in the plurality of properties. At block 906, the damage frequency model trainer 504 trains a first damage frequency model. At block 908, the validation engine 506 validates the first damage frequency model.

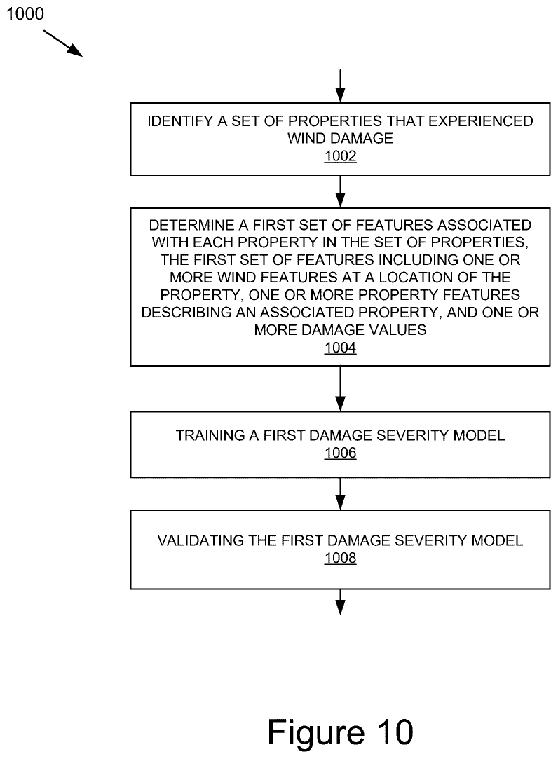

FIG. 10 is a flowchart of an example method 1000 for training a damage severity model in accordance with some implementations. At block 1002, the damage severity modeler 306 identifies a set of properties that experienced wind damage. At block 1004, the damage severity modeler 306 determines the first set of features associated with each property in the set of properties, the first set of features including one or more wind features at a location of the property, one or more property features describing an associated property, and one or more damage values. At block 1006, the damage severity modeler 306 trains a first damage severity model. At block 1008, the damage severity modeler 306 validates the first damage severity model.

### OTHER CONSIDERATIONS

It should be understood that the above-described examples are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

Reference in the specification to “one implementation” or “an implementation” or “some implementations” means that a particular feature, structure, or characteristic described in connection with the implementation is included in at least one implementation. The appearances of the phrase “in some implementations” in various places in the specification are not necessarily all referring to the same implementations.

In some instances, various implementations may be presented herein in terms of algorithms and symbolic representations of operations on data bits within a computer memory. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk, including floppy disks, optical disks, CD-ROMs, magnetic optical disks, read-only memories (ROMs), random access memories (RAMs), EPROMs, EEPROMs, magnetic or optical cards, or any type of media suitable for storing electronic instructions, each coupled to a computer system bus.

The disclosure can take the form of an entirely hardware implementation, an entirely software implementation, or an implementation containing both hardware and software elements. In a preferred implementation, the disclosure is implemented in software, which includes but is not limited to firmware, resident software, microcode, etc.

Furthermore, the disclosure can take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, a magnetic tape, a removable computer diskette, a random-access memory (RAM), a read-only memory (ROM), a flash memory, a rigid magnetic disk, and an optical disk. Current examples of optical disks include compact disk-read-only memory (CD-ROM), compact disk-read/write (CD-R/W), and DVD.

A data processing system suitable for storing and/or executing program code will include at least one processor coupled directly or indirectly to memory elements through a system bus. The memory elements can include local memory employed during the actual execution of the program code, bulk storage, and cache memories which provide temporary storage of at least some program code in order to reduce the number of times code must be retrieved from bulk storage during execution. For determining climate risk using artificial intelligence. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present disclosure is described with reference to a particular programming language. It will be appreciated that a variety of programming languages may be used to implement the teachings of the disclosure as described herein.

What is claimed is:

1. A computer implemented method comprising:
receiving, using one or more processors, a location;
determining, using the one or more processors, a wind speed associated with the location using a first wind speed machine learning model;
determining, using the one or more processors, a wind report frequency associated with the location using a first wind report frequency machine learning model;
obtaining, using the one or more processors, first feature data associated with the location, the first feature data including the wind speed associated with the location, the wind report frequency associated with the location, and data describing a first set of features at the location;
determining, using the one or more processors, a damage frequency metric associated with the location by applying a first damage frequency machine learning model to the first feature data;
obtaining, using the one or more processors, second feature data associated with the location, the second feature data including data describing a second set of features at the location; and
determining, using the one or more processors, a damage severity metric associated with the location by applying a first damage severity machine learning model to the second feature data.

2. The computer implemented method of claim 1, wherein the location is represented by a latitude and longitude.

3. The computer implemented method of claim 1, wherein the wind speed represents an average wind speed associated with the location.

4. The computer implemented method of claim 1, wherein wind report frequency represents one or more of a frequency of a wind report and a frequency of a wind report having an average wind speed that exceeds a threshold.

5. The computer implemented method of claim 1, wherein one or more of the first set of features includes one or more of: a vegetation density, a roof resilience score, a number of roof penetrations, a roof quality, one or more reasons generated by a roof quality reasoning model, a land cover code, a temperature, and a precipitation metric.

6. The computer implemented method of claim 1, wherein the one or more features at the location include a first feature obtained by applying a feature model to an aerial image of the location.

7. The computer implemented method of claim 6, wherein the feature model is a convolutional neural network.

8. The computer implemented method of claim 1 further comprising:
determining, based on one or more of the damage frequency metric and the damage severity metric, one or more of: a remedial action to reduce a wind damage metric; a determination of the wind damage metric; a warning to one or more of a property owner, a resident, and an entity associated with the location, the warning comprising the wind damage metric.

9. The computer implemented method of claim 1, wherein the first set of features at the location and the second set of features at the location are not mutually exclusive.

10. The computer implemented method of claim 1, wherein the second set of features includes one or more of a building area, a vegetation density, a roof material, a roof quality, a roof pitch, a roof height, a roof shape, a temperature, a temperature variation, and a precipitation metric.

11. A system comprising:
one or more processors; and
a memory, the memory storing instructions that, when executed by the one or more processors, cause the system to:
receive, using the one or more processors, a location;
determine, using the one or more processors, a wind speed associated with the location using a first wind speed machine learning model;
determine, using the one or more processors, a wind report frequency associated with the location using a first wind report frequency machine learning model;
obtain, using the one or more processors, first feature data associated with the location, the first feature data including the wind speed associated with the location, the wind report frequency associated with the location, and data describing a first set of features at the location;
determine, using the one or more processors, a damage frequency metric associated with the location by applying a first damage frequency machine learning model to the first feature data;
obtain, using the one or more processors, second feature data associated with the location, the second feature data including data describing a second set of features at the location; and
determine, using the one or more processors, a damage severity metric associated with the location by applying a first damage severity machine learning model to the second feature data.

12. The system of claim 11, wherein the location is represented by a latitude and longitude.

13. The system of claim 11, wherein the wind speed represents an average wind speed associated with the location.

14. The system of claim 11, wherein wind report frequency represents one or more of a frequency of a wind report and a frequency of a wind report having an average wind speed that exceeds a threshold.

15. The system of claim 11, wherein one or more of the first set of features includes one or more of: a vegetation density, a roof resilience score, a number of roof penetrations, a roof quality, one or more reasons generated by a roof quality reasoning model, a land cover code, a temperature, and a precipitation metric.

16. The system of claim 11, wherein the one or more features at the location include a first feature obtained by applying a feature model to an aerial image of the location.

17. The system of claim 16, wherein the feature model is a convolutional neural network.

18. The system of claim 11, wherein the instructions further cause the system to:
determine, based on one or more of the damage frequency metric and the damage severity metric, one or more of: a remedial action to reduce a wind damage metric; a determination of the wind damage metric; a warning to one or more of a property owner, a resident, and an entity associated with the location, the warning comprising the wind damage metric.

19. The system of claim 11, wherein the first set of features at the location and the second set of features at the location are not mutually exclusive.

20. The system of claim 11, wherein the second set of features includes one or more of a building area, a vegetation density, a roof material, a roof quality, a roof pitch, a roof height, a roof shape, a temperature, a temperature variation, and a precipitation metric.
